(19) United States
(12) Patent Application Publication
(10) Pub. No.: US 2008/0299249 A1
(43) Pub. Date: Dec. 4, 2008

(54) CENTER-FILL GUM COMPOSITIONS INCORPORATING TRIACETIN

(75) Inventors: William John Hirt, New York, NY (US); Jonathan Hipps, East Stroudsburg, PA (US); Craig Massey, Lake Hiawatha, NJ (US); Glenn Visscher, Morris Plains, NJ (US)

Correspondence Address: HOFFMANN & BARON, LLP, 6900 JERICHO TURNPIKE, SYOSSET, NY, 11791, US

(73) Assignee: CADBURY ADAMS USA LLC, Parsippany, NJ (US)

(21) Appl. No.: 12/130,323

(22) Filed: May 30, 2008

Related U.S. Application Data
(60) Provisional application No. 60/941,449, filed on Jun. 1, 2007.

(51) Int. Cl. A23G 4/20

(52) U.S. Cl. 426/5

(57) ABSTRACT

The present invention relates to compositions for a center-filled chewing gum product. The individual gum pieces include a center-fill composition surrounded by a gum region and optionally further surrounded by a coating. The chewing gum compositions include triacetin in the gum region and/or lecithin in the center-fill region, which reduces the amount of shrinkage and/or leakage of the product.

### CROSS-REFERENCE TO RELATED APPLICATION

This non-provisional application claims priority from U.S. Provisional Patent Application No. 60/941,449, filed Jun. 1, 2007, the entirety of which is incorporated by reference herein.

### FIELD

The present invention includes compositions for multi-layer center-filled chewing gum products. The individual chewing gum pieces which include the compositions of the present invention include a center surrounded by a gum region. Through the incorporation of triacetin into the gum region and/or lecithin into the center-fill region, the tendency of the products to shrink and/or leak is reduced.

### BACKGROUND

Liquid or center-filled gum products are in popular demand today. Typically, these products have a solid exterior portion and a soft or liquid-type center. The outer portion can be chewing gum or bubble gum of some type, while the liquid center portion may be a flavored material typically having a syrup-like consistency.

There has been a difficulty in preparing some center-filled products, however. It has been found that certain compositions tend to result in shrinkage of the gum composition, which in turn causes the product to open and leak. This is particularly problematic in liquid-filled chewing gum compositions. It has been found that by adding triacetin to the chewing gum region of the product, in addition to texture and flavor benefits, the shrinkage effect is considerably reduced, thus reducing the premature leakage that was experienced.

In addition, it has been found that certain oils used in gum products have a tendency to separate from the center-fill composition resulting in product quality inconsistency and manufacturing inefficiencies. Flavor oils can separate from the composition of the center-fill and collect, which may result in portions of the center-fill product that does not contain the flavor oil, but may also build up to such an amount that it begins to eat away at the gum portion. It has been found that by adding an effective amount of lecithin to the center-fill composition, product quality and process efficiency can be greatly increased. Further, by adding lecithin, the product does not require the addition of as much flavor oil as normally required, thus giving the same taste perception as conventional chewing gum products, with less flavoring. In fact, by adding lecithin, a similar taste perception may be obtained by adding an amount of flavor oil that is about 10% less than normally required.

### SUMMARY

In some embodiments there is provided a chewing gum composition including a center-fill composition and a gum region surrounding the center-fill composition, the gum region including a gum base and triacetin.

In some embodiments there is provided a chewing gum composition including a center-fill composition including lecithin, and a gum region surrounding the center-fill composition, the gum region including a gum base.

In some embodiments there is provided a chewing gum composition including a center-fill composition including lecithin, and a gum region surrounding the center-fill composition, the gum region including a gum base and triacetin.

In some embodiments there is provided a method of preparing a multi-layer center-fill gum product, including the steps of extruding a center-filled rope including a center-fill composition and a chewing guru layer surrounding the center-fill composition, the chewing gum layer including triacetin; sizing the rope; feeding the rope into a tablet-forming mechanism; forming individual pieces of chewing gum from the center-filled rope; and coating the individual pieces with a hard coating.

In some embodiments there is provided a method of preparing a multi-layer center-fill gum product including the steps of extruding a center-filled rope including a center-fill composition which includes lecithin and a chewing gum layer surrounding the center-fill composition which includes triacetin, sizing the rope; feeding the rope into a tablet-forming mechanism; forming individual pieces of chewing gum from the center-filled rope; and coating the individual pieces with a hard coating.

In some embodiments there is provided a chewing gum composition including a gum region, which includes a gum base, talc, lecithin, triacetin, hydrogenated starch hydrolysate, at least one polyol, at least one flavor, at least one acid, and at least one sweetener; a center-fill region, which includes glycerin, hydrogenated starch hydrolysate, at least one sweetener, xanthan gum, at least one acid, and at least one flavor; and a coating, which includes at least one polyol, gelatin, titanium dioxide, at least one flavor, at least one sweetener, and wax.

### DETAILED DESCRIPTION

In some embodiments there is a chewing gum composition which includes a center-fill composition and a gum region which surrounds the center-fill. The center-fill composition may include a fluid material, and may additionally include flavors and sweeteners. The gum region of the present invention may include a gum base and triacetin. Triacetin may be added to the gum region as part of the gum base and/or as a separate component. Triacetin adds to the texture and flavor of the chewing gum compositions. In addition, triacetin provides stability to the gum region, reducing the tendency of the gum region to shrink and/or reducing leakage of the center-fill composition from the gum composition until chewed by the consumer. The incorporation of triacetin also makes it easier to process center-filled gum products.

In some embodiments, the level of shrinkage is reduced to less than about 5-10% in any dimension after 24 hours of conventional conditioning. Specifically shrinkage is reduced to less than about 5%. Reduction in shrinkage can help prevent or reduce the likelihood of leakage of the center-fill composition.

Further, some embodiments may include lecithin in the center-fill composition, particularly in liquid center-fill compositions. The addition of lecithin to the product increases stability by creating an emulsion between the flavor oils and other center-fill components. By increasing the stability, the flavor oils are less likely to separate out and build up in the center-fill composition, thereby reducing, the problem of flavor oils eating through the surrounding gum region. This is particularly problematic during processing when concentrated flavor oils eat through the surrounding gum rope. Therefore, the incorporation of lecithin leads to processing efficiencies as well as a reduction in the amount of flavor needed to impart a desired taste perception.

A further embodiment may use both triacetin in the gum region, as well as lecithin in the center-fill composition. Such a composition may provide the stability benefits of the triacetin, as well as the stability benefits of the lecithin.

The inclusion of triacetin and lecithin into the respective regions of the chewing gum composition, as well as the size of the chewing gum product made therefrom and the composition of the gum base may have an effect on the stability of the products, particularly shrinkage and/or the tendency of the products to leak. Conventionally, the smaller the pellet size, the greater the tendency to leak. The chewing gum compositions described herein, however, can be used to form small gum pieces with less leakage than conventional center-fill products. More specifically, including triacetin in the gum region has been shown to reduce shrinkage, and thus reduce leakage. Including lecithin in the center-fill region has been shown to increase stability as well.

In some embodiments, triacetin may be included in the gum base of the chewing gum region and/or it may be included as a separate component in the chewing gum region. The gum base of the composition may include polyvinyl acetate in high molecular weights, low molecular weights, medium molecular weights, or a combination of all three. High molecular weight polyvinyl acetate means above approximately 55,000 molecular weight, medium molecular weight polyvinyl acetate means about 20,000 to 55,000 molecular weight, and low molecular weight polyvinyl acetate means about 5,000 to about 20,000 molecular weight. The ratio of low molecular weight polyvinyl acetate to high molecular weight polyvinyl acetate may be from about 50:1 to about 1:50. In some embodiments, the ratio may be about 10:1 to about 1:10.

In addition, the surface areas and sizes of various components in the gum region may additionally provide added stability. For instance, the filler in the gum base may have a surface area of from about 0.5 to about 10 m²/g, and some embodiments may have filler with a surface area from about 3-6 m²/g. The bulk sweetener in the gum region may have a surface area from about 0.1 to about 4 m²/g. In some embodiments, the gum region additionally may include talc, which may have particle sizes of from about 2 to about 50 microns. Some embodiments may have talc with particle sizes of from about 5 to about 25 microns.

As used herein the transitional term “comprising,” (also “comprises,” etc.) which is synonymous with “including,” “containing,” or “characterized by,” is inclusive or open-ended and does not exclude additional, unrecited elements or method steps, regardless of its use in the preamble or the body of a claim.

As used herein, the terms “bubble gum” and “chewing gum” are used interchangeably and are both meant to include any gum compositions.

As used herein, the terms “first region” and “center-fill” are used interchangeably to refer to the innermost region of the compositions. The term “center-fill” does not imply symmetry of a gum piece, only that the “center-fill” is within another region of the gum piece. In some embodiments, more than one center-fill may be present.

As used herein, the terms “second region” and “gum region” are used interchangeably to refer to a region of the compositions that may be adjacent to or at least partially surrounding the center-fill, or innermost, region. Similarly, the terms “second region” and “gum region” are used interchangeably to refer to a region of the compositions that may be adjacent to or at least partially surrounding the center-fill, or innermost, region.

As used herein, the terms “third region” and “coating” are used interchangeably to refer to the optional outermost region of the compositions.

As used herein, the terms “surround,” “surrounding,” and the like are not limited to encircling. These terms may refer to enclosing or confining on all sides, encircling or enveloping, and are not limited to symmetrical or identical thicknesses for a region in the gum product.

As used herein, the term “liquid” refers to compositions which will readily flow or maintain fluid properties at room temperature and pressure. The term “liquid” may include solutions, suspensions, emulsions, semi-solids, cremes, gels, etc. that may not be completely liquid.

As used herein, the term “triacetin” refers to the compound with a chemical name 1,3-diacetyloxypropan-2-yl acetate, also known as 1,2,3-triacetoxypropane and glycerin triacetate.

As used herein, the term “ingredient” and the term “component” are used interchangeably to describe any additive, fixing, substance, material, agent, active, element, or part that may be included in the gum compositions of some embodiments.

Embodiments described herein provide a multi-component composition which includes at least one center-fill composition, or region, and a gum region, which surrounds the center-fill composition. In some embodiments, the gum region includes triacetin, which improves the stability of the center-fill chewing gum composition. In some embodiments, the center-fill composition includes lecithin. Both triacetin and lecithin may be used in some embodiments.

In addition to the triacetin, the gum region includes an elastomer, as well as a variety of optional components. The individual gum piece also may include an outer coating or shell, which can provide a crunchiness to the piece when initially consumed. The individual pieces may form a variety of shapes including pellet, tablet, ball, pillow, chunk, stick and slab, among others.

In some embodiments, the components of the chewing gum composition may be in different configurations depending on the desired shape of the total composition. The center-fill area or areas may be in either a concentric configuration with respect to the gum region or in a layered configuration. A concentric configuration may be acceptable for a ball, pillow or pellet shape, while a layered configuration may be more suitable for a slab or a stick shape. For example, if the total composition is in a ball shape, a hollow, circular shell may be formed in the innermost region of the piece. The shell may be filled with a center-fill composition, and the other regions or layers of the piece may encircle the center-filled area. However, if the total composition is in a slab shape, a hollow shell formed in the innermost region may be of a rectangular shape. The rectangular-shaped shell may be filled with a center-fill composition, and the other regions or layers of the piece may enclose or confine the rectangular center-filled area on all sides of the rectangle.

In some embodiments, the gum region may have a non-uniform thickness. In particular, the gum region in layered configuration embodiments may be thinner on the ends than on the sides of the piece.

As mentioned above, the center-fill composition of the chewing gum composition may include a fluid carrier. Accordingly, the center-fill composition may be a liquid, semi-solid or the like. Certain center-fill compositions may additionally include a gas or a combination of a gas and fluid or solid composition. Such center-fill compositions may involve concerns regarding retention of the liquid center during manufacturing and shelf-life, as mentioned above. It may be desirable, therefore, to employ gum region compositions with liquid-fill products that substantially reduce or prevent leaking of the liquid center. Suitable gum region compositions are discussed in detail herein.

In some embodiments, the center-fill region may be substantially or completely filled with the center-fill composition. In some other embodiments, the center-fill region may be only partially filled with the center-fill composition.

In some embodiments, the center-fill region may include two or more center-fill compositions. The two or more center-fill compositions may be the same or different forms. For example, some embodiments may contain a mixture of two or more distinct liquids, which may or may not be miscible. Similarly, some embodiments may contain two or more distinct semi-solids in the center-fill region. Mixtures of different center-fill forms also may be included in some embodiments. For example, a liquid and a semi-solid may be included in the center-fill region. The two or more liquids and/or semi-solids employed in the center-fill composition may be included in the same or different amounts and may have similar or distinct characteristics. More specifically, in some embodiments, the two or more center-fill compositions may differ in a variety of characteristics, such as, viscosity, color, flavor, taste, sensation, ingredient components, functional components, sweeteners, or the like.

In some embodiments, the center-fill composition also may include additional non-liquid components, such as, for example, flavor beads, fruit particles, nut particles, flavor particles, gelatin portions, and the like.

The center-fill gum compositions described herein may be formed by any technique known in the art which includes the method described by U.S. Pat. No. 6,280,780 to Degady et al. (“Degady”) which is herein incorporated by reference in its entirety. Degady describes an apparatus and method for forming center-filled gum pellets. The method includes first extruding a liquid-filled rope of a chewing gum layer and passing the rope through a sizing mechanism including a series of pairs of pulley-shaped roller members. The roller members “size” the rope or strand of gum material such that it leaves the series of rollers with the desired size and shape for entering a tablet-forming mechanism.

The rope is then led into a tablet-forming mechanism including a pair of rotating chain die members which are endless chain mechanisms and both rotate at the same speed by a motor and gear mechanism. Each of the chain mechanisms include a plurality of open curved die groove members which mate and form die cavities in which the pieces of gum material (pellets or tablets) are formed. While Degady is limited to the formation of pellet or tablet shaped pieces, the gum pieces may be of other shapes as described above. The shape of the die groove members may be altered to provide any desired shape.

The gum may optionally be passed through a cooling tunnel either before entering the tablet-forming mechanism, after exiting the tablet-forming mechanism or both. Cooling of the rope prior to entering the tablet-forming mechanism may be beneficial to prevent rebound of the individual pieces and thus may provide an increase in productivity.

The cooled pieces of gum material are then fed into a storage container for conditioning and further processing. At this point, the cooled pieces of gum material could also be fed directly into a coating tunnel mechanism, such as a rotating tunnel mechanism.

Whether the pieces of formed gum material are first stored, transported in a storage container, or fed directly into a coating tunnel or mechanism, the individual pieces of gum material may subsequently be subjected to a conventional sugar or sugarless coating process in order to form a hard exterior shell on the liquid-filled gum material. A variety of coating processes or mechanisms of this type are known. In some embodiments, the coating is applied in numerous thin layers of material in order to form an appropriate uniform coated and finished quality surface on the gum products. The hard coating material, which may include sugar, maltitol, sorbitol or any other polyol, including those described herein, and optionally flavoring, is sprayed onto the pellets of gum material as they pass through a coating mechanism or a coating tunnel and are tumbled and rotated therein. In addition, conditioned air is circulated or forced into the coating tunnel or mechanism in order to dry each of the successive coating layers on the formed products. In some embodiments, the coating, or outermost region, can be formed by lamination, dual or multiple extrusion, or any other process that creates an outermost region.

The coating composition may range from about 2% to about 80%, more specifically, about 20% to about 40% by weight of an individual gum piece which includes a center-fill, a gum region and a coating; even more specifically, from 25% to 35% and still more specifically around 30%. The coating may include sugar or polyol such as maltitol as the primary component, but may also include flavors, colors, etc. as described below in the discussion of the gum region. The coating or outermost region may be crystalline or amorphous.

In some embodiments, the center-filled chewing gum product provides resistance from moisture migration from the center-fill to the gum region by modifying the center-fill composition to include lecithin and/or the gum region to include triacetin, as well as modifying the type of gum base. This is particularly relevant for liquid-fill chewing gum embodiments. This is in contrast to conventional approaches and which have not fully addressed the problems associated with manufacturing and shelf-stability of liquid center-filled products.

The size of the center-filled product may also affect the performance and stability of the gum composition. For instance, for center-fill pellets, the gum size is optimally between about 18-21 mm in length, about 12-16 mm in width, and about 7-10 mm in height. Desirably, the gum piece is about 19 mm in length, about 14 mm in width, and about 8 mm in height. The gum piece optimally weighs about 1.5-3 grams, and most desirably about 2 grams.

In some embodiments, there are included smaller piece-sizes. Historically, liquid center filled gum piece sizes ranged from about 5-7 grams. In some embodiments liquid filled products have been made using substantially smaller piece sizes, i.e., 50-60% smaller by weight, without loss of liquidity or migration of liquid into the gum region or beyond into the coating. Some embodiments provide a liquid-filled gum piece size range which is greater than about 0.5 grams, more specifically greater than 1.5 grams up to about 3 grams, including the addition of an outer hard coating shell. In addition, in some embodiments a gum piece may include a center-fill, a gum region including a gum base and an outer coating.

As mentioned above, it has been discovered that pieces of such small size and particularly with gum shapes or configurations having proportionally more liquid-fill surface area as compared to the weight of the liquid per se, have a greater tendency to lose the liquidity of the center due to the interaction of different factors. While not limited to a single theory, these factors include the amount of liquid-fill in comparison to the surface of the gum region in which the liquid-fill is in direct contact, the interaction of the type of elastomer with the center-fill (i.e. SBR versus non-SBR), the compatibility of the gum region components with the liquid-fill components, and the potential capillary action of the polyol used in the gum region.

For other useful center-fill gum compositions and/or components for use therein, see the following co-pending commonly owned patent applications, the contents of which are incorporated herein by reference in their entirety: U.S. application Ser. No. 11/710,830 (Attorney Docket No. 1421-5 CIP II), filed on Feb. 26, 2007, entitled “Liquid-Filled Chewing Gum Composition”; U.S. application Ser. No. 11/710,758 (Attorney Docket No. 1421-5 CIP III), filed on Feb. 26, 2007, entitled “Liquid-Filled Chewing Gum Composition”; U.S. application Ser. No. 11/408,761 (Attorney Docket No. 1421-5 CIP IV), filed on Apr. 21, 2006, entitled “Liquid-Filled Chewing Gum Composition”; U.S. application Ser. No. 11/411,543 (Attorney Docket No. 1421-137), filed on Apr. 26, 2006, entitled “Center-Filled Chewing Gum with Barrier Layer”; U.S. application Ser. No. 11/414,919 (Attorney Docket No. 1421-138A), filed on May 1, 2006, entitled “Center-Filled Chewing Gum Composition”; and U.S. application Ser. No. 11/415,043 (Attorney Docket No. 1421-139A), filed on May 1, 2006, entitled “Multi-Modality Chewing Gum Composition”.

### Gum Region

In some embodiments, the gum region surrounds the center-fill composition. The gum region, also referred to as the second region in center-fill chewing gum embodiments, may include one or more cavities therein to house the center-fill. The shape of the cavity will be largely dictated by the final configuration of the chewing gum piece.

The gum region incorporates an effective amount of triacetin, which maintains the stability of the gum region, reducing the likelihood of shrinkage and/or leakage. Flavor oils have been known to cause shrinkage in the gum region, and thus result in leakage. When the gum region shrinks, the seal covering the center-fill may open or rupture, allowing the center-fill to leak out of the gum product. This is particularly problematic in liquid-filled embodiments, as the moisture from the liquid filling migrates into the gum region and reduces the stability and thus the shelf-life of the product. Desirably, such shrinkage is reduced, if not eliminated. In addition to providing stability to the gum region, the addition of triacetin has been shown to allow for a more efficient process and better chewing texture for the consumer. Further, the addition of triacetin in the gum region allows for a gum piece that has dimensions, including length and width, which will vary less than a composition without incorporating triacetin. In some embodiments, the amount of triacetin used is between about 0.1-5%; by weight of the chewing gum composition, and in some embodiments is about 0.0.5-2% by weight of the chewing gum composntionl.

In some embodiments, the gum region may provide a liquid barrier to surround and prevent the liquid-fill from migration and premature release. By selection of the ratio of the desired cavity surface area to the liquid-fill weight, optimization of the reduction in potential liquid-fill migration in to the gum region area can be achieved. This is particularly useful when the gum piece size is desired to be substantially smaller than conventional commercialized gum pieces. In particular, liquid-filled pellet gums having sizes of 2 to 3 grams by weight of the entire gum piece have been successfully made. However smaller gum pieces, as small as about 0.5 grains are contemplated.

The gum region may include a gum base. As mentioned above, the triacetin may be included as a constituent in the gum base. The gum base also may include any component known in the chewing gum art. For example, the gum region may include elastomers, bulking agents, waxes, elastomer solvents, emulsifiers, plasticizers, fillers and mixtures thereof. In some embodiments, it has been found that varying the composition of the gum base also can affect the stability of the chewing gum composition. Wherein the gum region is included in a three component composition including a center-fill, a gum region and a coating layer, the gum region may comprise from about 40% to about 97%, more specifically from about 55% to about 65% by weight of the chewing gum piece, even more specifically about 62%.

The amount of the gum base which is present in the gum region may also vary. In some embodiments, the gum base may be included in the gum region in an amount from about 25% to about 45% by weight of the gum region. A more specific range of gum base in some embodiments may be from about 28% to about 42% by weight of the gum region. Even more specifically, the range may be from about 28% to about 35% or from about 28% to about 30% in some embodiments. Alternatively, in some high gum base embodiments, the gum base may be present in an amount from about 45% to about 100% by weight of the gum region.

The elastomers (rubbers) employed in the gum base will vary greatly depending upon various factors such as the type of gumn base desired, the consistency of gum composition desired and the other components used in the composition to make the final chewing gum product. The elastomer may be any water-insoluble polymer known in the art, and includes those gum polymers utilized for chewing gums and bubble gums. Illustrative examples of suitable polymers in gum bases include both natural and synthetic elastomers. For example, those polymers which are suitable in gum base compositions include, without limitation, natural substances (of vegetable origin) such as chicle, natural rubber, crown gum, nispero, rosidinha, jelutong, perillo, niger gutta, tunu, balata, guttapercha, lechi capsi, sorva, gutta kay, and the like, and combinations thereof. Examples of synthetic elastomers include, without limitation, styrene-butadiene copolymers (SBR), polyisobutylene, isobutylene-isoprene copolymers, polyethylene, polyvinyl acetate and the like, and combinations thereof.

Additional useful polymers include: crosslinked polyvinyl pyrrolidone, polymethylmethacrylate; copolymers of lactic acid, polyhydroxyalkanoates, plasticized ethylcellulose, polyvinyl acetatephthalate and combinations thereof.

The amount of elastomer employed in the gum base may vary depending upon various factors such as the type of gum base used, the consistency of the gum composition desired and the other components used in the composition to make the final chewing gum product. In general, the elastomer will be present in the gum base in an amount from about 10% to about 60% by weight of the gum region, desirably from about 35% to about 40% by weight.

In some embodiments, the gum base may include wax. It softens the polymeric elastomer mixture and improves the elasticity of the gum base. When present, the waxes employed will have a melting point below about 60° C., and preferably between about 45° C. and about 55° C. The low melting wax may be a paraffin wax. The wax may be present in the gum base in an amount from about 6% to about 10%, and preferably from about 7% to about 9.5%, by weight of the gum base.

In addition to the low melting point waxes, waxes having a higher melting point may be used in the gum base in amounts up to about 5%, by weight of the gum base. Such high melting waxes include beeswax, vegetable wax, candelilla wax, carnuba wax, most petroleum waxes, and the like, and mixtures thereof.

In addition to the components set out above, the gum base may include a variety of other ingredients, such as components selected from elastomer solvents, emulsifiers, plasticizers, fillers, and mixtures thereof.

The gum base may contain elastomer solvents to aid in softening the elastomer component. Such elastomer solvents may include those elastomer solvents known in the art, for example, terpinene resins such as polymers of alpha-pinene or beta-pinene, methyl, glycerol and pentaerythritol esters of rosins and modified rosins and gums such as hydrogenated, dimerized and polymerized rosins, and mixtures thereof. Examples of elastomer solvents suitable for use herein may include the pentaerythritol ester of partially hydrogenated wood and gum rosin, the pentaerythritol ester of wood and gum rosin, the glycerol ester of wood rosin, the glycerol ester of partially dimerized wood and gum rosin, the glycerol ester of polymerized wood and gum rosin, the glycerol ester of tall oil rosin, the glycerol ester of wood and gum rosin and the partially hydrogenated wood and gum rosin and the partially hydrogenated methyl ester of wood and rosin, and the like, and mixtures thereof. The elastomer solvent may be employed in the gum base in amounts from about 2% to about 15%, and preferably from about 7% to about 11%, by weight of the gum base.

The gum base may also include emulsifiers which aid in dispersing the immiscible components into a single stable system. The emulsifiers useful in this invention include glyceryl monostearate, lecithin, fatty acid monoglycerides, diglycerides, propylene glycol monostearate, and the like, and mixtures thereof. The emulsifier may be employed in amounts from about 2% to about 15%, and more specifically, from about 7% to about 11%, by weight of the gum base.

The gum base may also include plasticizers or softeners to provide a variety of desirable textures and consistency properties. Because of the low molecular weight of these ingredients, the plasticizers and softeners are able to penetrate the fundamental structure of the gum base making it plastic and less viscous. Useful plasticizers and softeners include lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, and the like, and mixtures thereof. Waxes, for example, natural and synthetic waxes, hydrogenated vegetable oils, petroleum waxes such as polyurethane waxes, polyethylene waxes, paraffin waxes, microcrystalline waxes, fatty waxes, sorbitan monostearate, tallow, propylene glycol, mixtures thereof and the like, may also be incorporated into the gum base. The plasticizers and softeners are generally employed in the gum base in amounts up to about 20% by weight of the gum base, and more specifically in amounts from about 9% to about 17%, by weight of the gum base.

Plasticizers also include are the hydrogenated vegetable oils and include soybean oil and cottonseed oil which may be employed alone or in combination. These plasticizers provide the gum base with good texture and soft chew characteristics. These plasticizers and softeners are generally employed in amounts from about 5% to about 14%, and more specifically in amounts from about 5% to about 13.5%, by weight of the gum base.

Anhydrous glycerin may also be employed as a softening agent, such as the commercially available United States Pharrnacopeia (USP) grade. Glycerin is a syrupy liquid with a sweet warm taste and has a sweetness of about 60% of that of cane sugar. Because glycerin is hygroscopic, the anhydrous glycerin may be maintained under anhydrous conditions throughout the preparation of the chewing gum composition.

In some embodiments, the gum base of this invention may also include effective amounts of bulking agents such as mineral adjuvants which may serve as fillers and textural agents. Useful mineral adjuvants include calcium carbonate, magnesium carbonate, alumina, aluminum hydroxide, aluminum silicate, talc, tricalcium phosphate, dicalcium phosphate, calcium sulfate and the like, and mixtures thereof. These fillers or adjuvants may be used in the gum base compositions in various amounts. The amount of filler, may be present in an amount from about zero to about 40%. and more specifically from about zero to about 30%, by weight of the gum base. In some embodiments, the amount of filler will be from about zero to about 15%, more specifically from about 3% to about 11%.

A variety of traditional ingredients may be optionally included in the gum base in effective amounts such as coloring agents, antioxidants, preservatives, flavoring agents, high intensity sweeteners, and the like. For example, titanium dioxide and other dyes suitable for food, drug and cosmetic applications, known as F. D. & C. dyes, may be utilized. An anti-oxidant such as butylated hydroxytoluene (BHT), butylated hydroxyanisole (BHA), propyl gallate, and mixtures thereof, may also be included. Other conventional chewing gum additives known to one having ordinary skill in the chewing gum art may also be used in the gum base. A variety of components which may be added to the gum region, or alternatively to the liquid-fill region or coating are described in greater detail in the section entitled “Additional Components” hereinbelow.

Some embodiments extend to methods of making the center-fill gum compositions. The manner in which the gum base components are mixed is not critical and is performed using standard techniques and apparatus known to those skilled in the art. In a typical method, an elastomer is admixed with an elastomer solvent and/or a plasticizer and/or an emulsifier and agitated for a period of from 1 to 30 minutes. The remaining ingredients, such as the low melting point wax, are then admixed, either in bulk or incrementally, while the gum base mixture is blended again for 1 to 30 minutes

The gum composition may include amounts of conventional additives selected from the group consisting of sweetening agents (sweeteners), plasticizers, softeners, emulsifiers, waxes, fillers, bulking agents (carriers, extenders, bulk sweeteners), mineral adjuvants, flavoring agents (flavors, flavorings), coloring agents (colorants, colorings), antioxidants, acidulants, thickeners, medicaments, and the like, and mixtures thereof. Some of these additives may serve more than one purpose. For example, in sugarless gum compositions, a sweetener, such as maltitol or other sugar alcohol, may also function as a bulking agent.

The plasticizers, softening agents, mineral adjuvants, waxes and antioxidants discussed above, as being suitable for use in the gum base, may also be used in the chewing gum composition. Examples of other conventional additives which may be used include emulsifiers, such as lecithin and glycerol monostearate, thickeners, used alone or in combination with other softeners, such as methyl cellulose, alginates, carrageenan, xanthan gum, gelatin, carob, tragacanth, locust bean gum, pectin, alginates, galactomannans such as guar gum, carob bean gum, glucomannan, gelatin, starch, starch derivatives, dextrins and cellulose derivatives such as carboxy methyl cellulose, acidulants such as malic acid, adipic acid, citric acid, tartaric acid, fumaric acid, and mixtures thereof, and fillers, such as those discussed above under the category of mineral adjuvants.

In some embodiments, the gum region may also contain a bulking agent. Suitable bulking agents may be water-soluble and include sweetening agents selected from, but not limited to, monosaccharides, disaccharides, polysaccharides, sugar alcohols, and mixtures thereof, randomly bonded glucose polymers such as those polymers distributed under the tradename Litesse™ which is the brand name for polydextrose and is manufactured by Danisco Sweeteners, Ltd. of 41-51 Brighton Road, Redhill, Surryey, RH1 6YS, United Kingdom.; isomalt (a racemic mixture of alpha-D-glucopyranosyl-1,6-mannitol and alpha-D-glucopyranosyl-1,6-sorbitol manufactured under the tradename PALATINIT by Palatinit Sussungsmittel GmbH of Gotlieb-Daimler-Strause 12 a, 68165 Mannheim, Germany); maltodextrins; hydrogenated starch hydrolysates; hydrogenated hexoses; hydrogenated disaccharides; minerals, such as calcium carbonate, talc, titanium dioxide, dicalcium phosphate; celluloses; and mixtures thereof.

Suitable sugar bulking agents include monosaccharides, disaccharides and polysaccharides such as xylose, ribulose, glucose (dextrose), lactose, mannose, galactose, fructose (levulose), sucrose (sugar), maltose, invert sugar, partially hydrolyzed starch and corn syrup solids, and mixtures thereof.

Suitable sugar alcohol bulking agents include sorbitol, xylitol, mannitol, galactitol, lactitol, maltitol, erythritol, isomalt and mixtures thereof.

Suitable hydrogenated starch hydrolysates include those disclosed in U.S. Pat. No. 4,279,931 and various hydrogenated glucose syrups and/or powders which contain sorbitol, maltitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN®, a commercially available product manufactured by Roquette Freres of France, and HYSTAR®, a commercially available product manufactured by SPI Polyols, Inc. of New Castle, Del., are also useful.

The sweetening agents which may be included in the compositions of some embodiments may be any of a variety of sweeteners known in the art. These are described in more detail in the “Additional Components” section herein below and may be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and mixtures thereof.

Desirably, the sweetener is a high intensity sweetener such as aspartame, neotame, sucralose, and acesulfame potassium (Ace-K).

In general, an effective amount of sweetener may be utilized to provide the level of sweetness desired, and this amount may vary with the sweetener selected. In some embodiments the amount of sweetener may be present in amounts from about 0.001% to about 3%, by weight of the gum composition, depending upon the sweetener or combination of sweeteners used. The exact range of amounts for each type of sweetener may be selected by those skilled in the art.

Coloring agents may be used in amounts effective to produce the desired color. The coloring agents may include pigments which may be incorporated in amounts up to about 6%, by weight of the gum composition. For example, titanium dioxide may be incorporated in amounts up to about 2%, and preferably less than about 1%, by weight of the gum composition. The colorants may also include natural food colors and dyes suitable for food, drug and cosmetic applications. These colorants are known as F.D.& C. dyes and lakes. The materials acceptable for the foregoing uses are preferably water-soluble. Illustrative nonlimiting examples include the indigoid dye known as F.D.& C. Blue No.2, which is the disodium salt of 5,5-indigotindisulfonic acid. Similarly, the dye known as F.D.& C. Green No.1 comprises a triphenylmethane dye and is the monosodium salt of 4-[4-(N-ethyl-p-sulfoniumbenzylamino)diphenylmethylene]-[1-(1N-ethyl-N-p-sulfoniumbenzyl)-delta-2,5-cyclohexadieneimine]. A full recitation of all F.D.& C. colorants and their corresponding chemical structures may be found in the Kirk-Othmer Encyclopedia of Chemical Technology, 3rd Edition, in volume 5 at pages 857-884, which text is incorporated herein by reference. Additional coloring components are described in the “Additional Components” section hereinbelow.

Suitable oils and fats usable in gum compositions include partially hydrogenated vegetable or animal fats, such as coconut oil, palm kernel oil, beef tallow, and lard, among others. These ingredients when used are generally present in amounts up to about 7%, and preferably up to about 3.5%, by weight of the gum composition.

Some embodiments may include a method for preparing the improved chewing gum compositions for the gum region, including both chewing gum and bubble gum compositions. The chewing gum compositions may be prepared using standard techniques and equipment known to those skilled in the art. The apparatus useful in accordance with some embodiments comprises mixing and heating apparatus well known in the chewing gum manufacturing arts, and therefore the selection of the specific apparatus will be apparent to the artisan.

With respect to the center-fill layer, the gum region may have a water activity greater than or equal to the water activity of the center-fill composition. However, in compositions wherein a greater water activity is desired in the center or liquid-fill, the water activity of the center-fill composition may be greater than that of the gum region. A higher moisture content will aid in hydration of thickeners like xanthan gum and cellulose when present in the center-fill.

The gum region may have a total moisture content of about 14% by weight of the gum region and more specifically may have a total moisture content from about 9% to about 14% by weight, with a free moisture content of less than about 5%. The center-fill further may have total moisture content including free and bound moisture from about zero up to about 35% by weight of said center-fill, specifically about 22%.

### Center-Fill Composition

The center-fill composition, or region, is located adjacent to or within the gum region, described above. The center-fill, also referred to as the interior portion or the first region, of the chewing gum composition can take the physical form of a liquid, gas or a semi-solid. In some embodiments, the center-fill composition includes a fluid carrier. In some embodiments, the carrier is a hydrophilic carrier. Accordingly, the fluid carrier can be a liquid or semi-liquid. As mentioned above in some embodiments the center-fill composition also includes lecithin, which improves the stability of the chewing gum composition.

The lecithin in the center-fill composition may be included in an amount of from about 0.1% by weight of the center-fill composition to about 2% by weight of the center-fill composition. In some embodiments, the lecithin is present in an amount from about 0.05 to about 0.5% by weight of the center-fill composition. The addition of lecithin in the center-fill region has been found to allow for a lesser amount of flavoring to be added to the center-fill composition to achieve the same taste perception. The flavoring may be added in an amount that is less than about 10% of the amount used in conventional center-filled chewing gums. For instance, conventional products typically use about 5% flavor based on the weight of the center-fill composition. In contrast, in some embodiments described herein, the amount of flavor is less than about 1%, and in some other embodiments, the flavor is about 0.5% by weight of the center-fill composition.

Examples of suitable fluid carriers include, but are not limited to, glycerin, hydrogenated starch hydrolysates, corn syrups, sorbitol syrups, dextrose syrups, sugar syrups, maltitol syrups, propylene glycol, hydrocolloids, polyglycitol syrups and combinations thereof.

Suitable hydrogenated starch hydrolysates include those disclosed in U.S. Pat. No. 4,279,931 and various hydrogenated glucose syrups and/or powders which contain sorbitol, maltitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN®, a commercially available product manufactured by Roquette Freres of France, and HYSTAR®, a commercially available product manufactured by SPI Polyols, Inc. of New Castle, Del., are also useful.

In general, the center-fill composition is present in the chewing gum composition in amounts of about 8% to about 11% by weight of the total composition, more specifically about 8.6% to about 10.5% by weight of the total composition, and even more specifically about 9% to about 10% by weight of the total composition. In some embodiments, the fluid carrier is present in the center-fill composition in amounts of about 10% to about 65% by weight of the center-fill composition.

The center-fill composition also may include at least one flavor agent and/or at least one cooling agent. Examples of suitable flavor agents and cooling agents are provided herein in the section entitled “Additional Components”. In some embodiments, a pre-mix of a flavor agent and a cooling agent may be included. The flavor agent may be a liquid, such as a flavor oil, in which the cooling agent may be dissolved.

In some embodiments described herein, the liquid centers may present viscosity differences that can be manipulated for a desired effect. In some embodiments, liquid centers can be formulated to have low viscosities that consumers perceive as refreshing. In some embodiments, the viscosity of the liquid center can be manipulated for a variety of reasons including, but not limited to, processing efficiency or creation of a desired perception. In some embodiments, the viscosity of the liquid center can be 3,000 to 10,000 pascal seconds. In some embodiments, the viscosity of the liquid center can be 4,000 to 6,500 pascal seconds.

In some embodiments, the water activity of the liquid center can be manipulated for a variety of reasons including, but not limited to, microbial stability or maintenance of a desired texture. In some embodiments, the water activity of the liquid center can be 0.1 to 0.7. In some embodiments, the water activity of the liquid center can be 0.25 to 0.35.

Liquids that can be included in the liquid center in some embodiments can include, but are not limited to, fruit juice; vegetable juice; fruit puree; fruit pulp; vegetable pulp; vegetable puree; fruit sauce; vegetable sauce; honey; maple syrup; molasses; corn syrup; sugar syrup; polyol syrup; hydrogenated starch hydrolysates syrup; emulsions; vegetable oil; glycerin; propylene glycol; ethanol; liqueurs; chocolate syrup, dairy-based liquids such as milk, cream, etc.; and combinations thereof.

The center-fill compositions also may include any components known in the art for incorporation with a center-fill composition. In some embodiments, particularly liquid-fill embodiments, for instance, this may include glycerine in addition to one or more other polyols in amounts greater than zero up to about 20%, more specifically, up to about 10% by weight of the total chewing gum composition, i.e., including a center-fill composition, a gum region and a coating. In some embodiments, the center-fill is approximately 8% by weight of the total chewing gum composition.

In some embodiments, the centers may contain those traditional ingredients well known in the chewing gum and confectionery arts, such as flavoring agents, sweetening agents, and the like, and mixtures thereof, as described above. In addition to confectionery additives, the centers may also contain pharmaceutical additives such as medicaments, breath fresheners, vitamins, minerals, caffeine, fruit juices, and the like, and mixtures thereof. The confectionery and pharmaceutical agents may be used in many distinct physical forms well known in the art to provide an initial burst of sweetness and flavor and/or therapeutic activity or a prolonged sensation of sweetness and flavor and/or therapeutic activity. Without being limited thereto, such physical forms include free forms, such as spray dried, powdered, and beaded forms, and encapsulated forms, and mixtures thereof. Illustrative, but not limiting, examples of liquid centers suitable for use in some embodiments include those centers disclosed in U.S. Pat. Nos. 3,894,154, 4,156,740, 4,157,402, 4,316,915, and 4,466,983, which disclosures are incorporated herein by reference. Specific examples of suitable additional components include taurine, guarana, vitamins, Actizol™, chlorophyll, Recaldent™ tooth remineralization technology, and Retsyn™ breath freshening technology.

In some embodiments, the center-fill composition also may include a natural or synthetic gum such as carboxymethylcellulose, pectin, propylene glycol aginate, agar and gum tragacanth. These compositions serve to increase viscosity by reducing the amount of free water in the composition. The viscosity of the center-fill may range from about 300 cp to about 6,000 cp at 25° C. In liquid-fill compositions which have a greater water activity than the surrounding gum region, the viscosity may range from about 3,000 cp to about 6,000 cp at 25° C.

Xanthan gum may also be used to increase the viscosity of the center-fill composition. In some liquid-fill embodiments, increasing viscosity of the liquid also helps prevent the liquid from leaking through the gum piece. Xanthan gum is available under the tradename Keltrol® from Signet Chemical Corporation.

Some embodiments extend to methods of making the center-filled compositions. The compositions may be prepared using standard techniques and equipment known to those skilled in the art. The apparatus useful in accordance with the embodiments described herein comprises mixing and heating apparatus well known in the chewing gum manufacturing arts, and therefore the selection of the specific apparatus will be apparent to the artisan. Such methods and apparatus are disclosed, for example, in U.S. Pat. Nos. 3,806,290 and 3,857,963, which disclosures are incorporated herein by reference.

### Coating Composition

The coating composition, when included in the center-fill compositions, may be applied by any method known in the art including the method described above. The coating may surround at least a portion of the gum region. The coating composition may be present in an amount from about 2% to about 60%, more specifically from about 25% to about 35% by weight of the total center-filled gum piece, even more specifically about 30% by weight of the piece. The coating composition may have any desired thickness, and typically has a thickness of from about 1 micron to about 7 mm.

The outer coating may be hard, crunchy, or soft. Typically, the outer coating may include sorbitol, maltitol, xylitol, erythritol, isomalt, and other crystallizable polyols; sucrose may also be used. Furthermore the coating may include several opaque layers, such that the chewing gum composition is not visible through the coating itself, which can optionally be covered with a further one or more transparent layers for aesthetic, textural and protective purposes. The outer coating may also contain small amounts of water and gum arabic. The coating can be further coated with wax. The coating may be applied in a conventional manner by successive applications of a coating solution, with drying in between each coat. As the coating dries it usually becomes opaque and is usually white, though other colorants may be added. A polyol coating can be further coated with wax. The coating can further include colored flakes or speckles. If the composition comprises a coating, it is possible that one or more oral care actives can be dispersed throughout the coating. This is especially preferred if one or more oral care actives is incompatible in a single phase composition with another of the actives. Flavors may also be added to yield unique product characteristics.

In some embodiments, the coating may also be formulated to assist with increasing the thermal stability of the gum piece and preventing leaking of the liquid fill. In some embodiments, the coating may include a gelatin composition. The gelatin composition may be added as a 40% by weight solution and may be present in the coating composition from about 5% to about 10% by weight of the coating composition, and more specifically about 7% to about 8%. The gel strength of the gelatin may be from about 130 bloom to about 250 bloom.

Other materials may be added to the coating to achieve desired properties. These materials may include without limitation, cellulosics such as carboxymethyl cellulose, gelatin, pullulan, alginate, starch, carrageenan, xanthan gum, gum arabic and polyvinyl acetate (PVA). The coating may further include active agents or medicaments if desired.

The coating composition may also include a pre-coating which is added to the individual gum pieces prior to an optional hard coating. The pre-coating may include an application of polyvinyl acetate (PVA). This may be applied as a solution of PVA in a solvent, such as ethyl alcohol. When an outer hard coating is desired, the PVA application may be approximately 3% to 4% by weight of the total coating or about 1% of the total weight of the gum piece (including a center-fill, gum region and hard coating).

Various other coating compositions and methods of malcing are also contemplated including but not limited to soft panning, dual or multiple extrusion, lamination, etc. Thus, in some embodiments, the coating can be amorphous or crystalline and the resulting texture can be hard, crunchy, crispy, soft, or chewy.

### Additional Components

In Additional additives, such as warming agents, cooling agents, tingling agents, flavors, sweeteners, sour tastes, bitter tastes, salty tastes, surfactants, breath freshening agents, anti-microbial agents, anti-bacterial agents, anti-calculus agents, antiplaque agents, fluoride compounds, remineralization agents, pharmaceuticals, micronutrients, throat care actives, tooth whitening agents, energy boosting agents, concentration boosting agents, appetite suppressants, colors and other actives may also be included in any or all portions or regions of the chewing gum composition. Such components may be used in amounts sufficient to achieve their intended effects.

Any of the additional components discussed herein may be added to any region of the center-fill chewing gum composition in their modified release form and/or without modified release (sometimes referred to as “free” components). In some embodiments, for instance, a single component may be added to the center-filled composition in its modified release form and free form. The modified release component and free component may be included together in the same region of the center-filled composition or, in some embodiments, the two components may be included in different regions of the composition.

In some other embodiments, for instance, two different components that provide the same functionality, e.g., two different flavors, sweeteners, tastes, sensations, or the like, may be included in a center-fill chewing gum composition. In some embodiments, both components may have modified release properties. Alternatively, in some embodiments, one of the components may be modified release, whereas the other component may be free. The two components may be included in the same or different regions of the center-filled composition.

Types of individual ingredients for which optional managed release from a chewing gum composition may be desired, include, but are not limited to sweeteners, flavors, actives, effervescing ingredients, appetite suppressors, breath fresheners, dental care ingredients, emulsifiers, flavor potentiators, bitterness masking or blocking ingredients, food acids, micronutrients, sensates, mouth moistening ingredients, throat care ingredients, colors, sour agents, bitter agents, salty agents, pharmaceuticals, energy boosting agents, concentration boosting agents and combinations thereof. Ingredients may be available in different forms such as, for example, liquid form, spray-dried form, or crystalline form. In some embodiments, chewing gum composition may include the same type of ingredient n different forms. For example, a chewing gum composition may include a liquid flavor and a spray-dried version of the same flavor. In some embodiments, the ingredient may be in its free or encapsulated form and may be present in any region of the gum composition such as in the center-fill, the gum region, or the coating.

In some embodiments, an ingredient's release is modified such that when a consumer chews the chewing gum, they may experience an increase in the duration of flavor or sweetness perception and/or the ingredient is released or otherwise made available over a longer period of time. Modified release may be accomplished by any method known in the art, such as by encapsulation. Where modified release is due to encapsulation, this may be accomplished by a variety of means such as by spray coating or extrusion.

Additionally, if early and extended release of the ingredient is desired, the chewing gum composition may include ingredients without modified release (sometimes referred to as “free” ingredients), as well as ingredients with modified release. In some embodiments, a free ingredient may be used to deliver an initial amount or “hit” of an ingredient (e.g., flavor, cooling agent) or an initial sensation or benefit caused by the ingredient (e.g., flavor, nasal action, cooling, warming, tingling, saliva generation, breath freshening, teeth whitening, throat soothing, mouth moistening, etc.). In some embodiments, the same ingredient can be provided with modified release characteristics to provide an additional or delayed amount of the same sensation or benefit. By using both the free ingredient and the ingredient with modified release characteristics, the sensation or benefit due to the ingredient may be provided over a longer period of time and/or perception of the sensation or benefit by a consumer may be improved. Also, in some embodiments the initial amount or “hit” of the ingredient may predispose or precondition the consumers' mouth or perception of the chewing gum composition.

As another example, in some embodiments it may be desirable to provide a sustained release of an ingredient in a chewing gum composition over time. To accomplish sustained release, the ingredient may be modified to allow for a lower concentration of the ingredient to be released over a longer period of time versus the release of a higher concentration of the ingredient over a shorter period of time. A sustained release of an ingredient may be advantageous in situations when the ingredient has a bitter or other bad taste at the higher concentrations. A sustained release of an ingredient also may be advantageous when release of the ingredient in higher concentrations over a shorter period of time may result in a lesser amount of the ingredient being optimally delivered to the consumer. For example, for a tooth whitening or breath freshening ingredient, providing too much of the ingredient too fast may result in a consumer swallowing a significant portion of the ingredient before the ingredient has had a chance to interact with the consumer's teeth, mucous membranes, and/or dental work, thereby wasting the ingredient or at least reducing the benefit of having the ingredient in the chewing gum composition.

In some embodiments described herein, the gum region of the chewing gum composition may include at least one modified release component. At least one modified release component optionally may be added to the center-fill and/or coating, as well. The additional modified release component that may be included in the center-fill and/or coating may be the same as or different from the modified release component contained in the gum region.

### Flavors

In some embodiments, flavorants may include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof. The flavorant may be a hydrophobic flavorant, in some embodiments.

Nonlimiting representative flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, yazu, sudachi, and fruit essences including apple, pear, peach, grape, berry, blueberry, strawberry, raspberry, cherry, plum, pineapple, apricot, banana, melon, apricot, ume, cherry, raspberry, blackberry, black currant, tropical fruit, mango, mangosteen, pomegranate, papaya and so forth. Other potential flavors whose release profiles can be managed include a milk flavor, a butter flavor, a cheese flavor, a cream flavor, and a yogurt flavor; a vanilla flavor; a creamy vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with the cooling agents, described herein below.

In some embodiments, other flavorings include aldehydes and esters such as cinnamyl acetate, cinnamaldehyde, citral diethylacetal, dihydrocarvyl acetate, eugenyl formate, p-methylamisol, and so forth may be used. Generally any flavoring or food additive such as those described in Chemicals Used in Food Processing, publication 1274, pages 63-258, by the National Academy of Sciences, may be used. This publication is incorporated herein by reference. These may include natural as well as synthetic flavors.

Further examples of aldehyde flavorings include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e. trans-2 (berry fruits), tolyl aldehyde (cherry, almond), veratraldehyde (vanilla) 2,6-dimethyl-5-heptenal, e., melonal (melon), 2,6-dimethyloctanal (green fruit), and 2-dodecenal (citrus, mandarin), cherry, grape, blueberry, blackberry, strawberry, shortcake, and mixtures thereof.

In some embodiments, a flavoring agent may be employed in either liquid form and/or dried form. When employed in the latter form, suitable drying means such as spray drying the liquid may be used. Alternatively, the flavoring agent may be absorbed onto water soluble materials, such as cellulose, starch, sugar, maltodextrin, gum arabic and so forth or may be encapsulated. In still other embodiments, the flavoring agent may be adsorbed onto silicas, zeolites, and the like.

In some embodiments, the flavoring agents may be used in many distinct physical forms. Without being limited thereto, such physical forms include free forms, such as spray dried, powdered, beaded forms, encapsulated forms, and mixtures thereof.

The flavors may be encapsulated to modify their release. Typically, encapsulation of a component will result in a delay in the release of the predominant amount of the component during consumption of a chewing gum composition that includes the encapsulated component (e.g., as part of a delivery system added as an ingredient to the chewing gum composition). In some embodiments, the release profile of the ingredient (e.g., the flavor, sweetener, etc.) can be managed by managing various characteristics of the ingredient, delivery system containing the ingredient, and/or the chewing gum composition containing the delivery system and/or how the delivery system is made. For example, characteristics might include one or more of the following: tensile strength of the delivery system, water solubility of the ingredient, water solubility of the encapsulating material, water solubility of the delivery system, ratio of ingredient to encapsulating material in the delivery system, average or maximum particle size of ingredient, average or maximum particle size of ground delivery system, the amount of the ingredient or the delivery system in the chewing gum composition, ratio of different polymers used to encapsulate one or more ingredients, hydrophobicity of one or more polymers used to encapsulate one or more ingredients, hydrophobicity of the delivery system, the type or amount of coating on the delivery system, the type or amount of coating on an ingredient prior to the ingredient being encapsulated, etc.

### Sweetening Agents

The sweeteners involved may be selected from a wide range of materials including water-soluble sweeteners, water-soluble artificial sweeteners, water-soluble sweeteners derived from naturally occurring water-soluble sweeteners, dipeptide based sweeteners, and protein based sweeteners, including mixtures thereof. Without being limited to particular sweeteners, representative categories and examples include:

(a) water-soluble sweetening agents such as dihydrochalcones, monellin, stevia, steviosides, rebaudioside A, glycyrrhizin, dihydroflavenol, and sugar alcohols such as sorbitol, mannitol, maltitol, xylitol, erythritol and L-aminodicarboxylic acid aminoalkanoic acid ester amides, such as those disclosed in U.S. Pat. No. 4,619,834, which disclosure is incorporated herein by reference, and mixtures thereof;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof;

(c) dipeptide based sweeteners, such as L-aspartic acid derived sweeteners, such as L-aspartyl-L-phenylalanine methyl ester (Aspartame) and materials described in U.S. Pat. No. 3,492,131 L-alphaaspartyl-N-(2,2,4,4-tetramethyl-3-thietanyl)-D-alaninamide hydrate (Alitame), N-[N-(3,3-dimethylbutyl)-L-aspartyl]-L-phenylalanine 1-methyl ester (Neotame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose, 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro4,6,1′,6′-tetradeoxygalacto-sucrose; and 4,6,1′,6′-tetradeoxy-sucrose, and mixtures thereof;

(e) protein based sweeteners such as thaumatococcus danielli (Thaumatin I and II) and talin;

(f) the sweetener monatin (2-hydroxy-2-(indol-3-ylmethyl)-4-aminoglutaric acid) and its derivatives; and

(g) the sweetener Lo han guo (sometimes also referred to as “Lo han kuo”).

The intense sweetening agents may be used in many distinct physical forms well-known in the art to provide an initial burst of sweetness and/or a prolonged sensation of sweetness. Without being limited thereto, such physical forms include free forms, spray dried forms, powdered forms, beaded forms, encapsulated forms, and mixtures thereof. In one embodiment, the sweetener is a high intensity sweetener such as aspartame, sucralose, and acesulfame potassium (e.g., Ace-K).

In some embodiments, the sweetener may be a polyol. Polyols can include, but are not limited to glycerol, sorbitol, maltitol, maltitol syrup, mannitol, isomalt, erythritol, xylitol, hydrogenated starch hydrolysates, polyglycitol syrups, polyglycitol powders, lactitol, and combinations thereof.

The active component (e.g., sweetener), which is part of the chewing gum composition, may be used in amounts necessary to impart the desired effect associated with use of the active component (e.g., sweetness). In general, an effective amount of intense sweetener may be utilized to provide the level of sweetness desired, and this amount may vary with the sweetener selected. The intense sweetener may be present in amounts from about 0.001% to about 3%, by weight of the composition, depending upon the sweetener or combination of sweeteners used. The exact range of amounts for each type of sweetener may be selected by those skilled in the art.

### Sensates

Sensate compounds can include cooling agents, warming agents, tingling agents, effervescent agents, and combinations thereof. A variety of well known cooling agents may be employed. For example, among the useful cooling, agents are included xylitol, erythritol, dextrose, sorbitol, menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-p-menthane-3-carboxamide (WS-3), isopulegol, 3(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLAT® type MGA); 3-1-menthoxypropane-1,2-diol (from Takasago, FEMA 3784); and menthyl lactate; (from Haarman & Reimer, FEMA 3748, tradename FRESCOLAT® type ML), WS-30, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo (2.2.1), Heptane-2-carboxamide; and Menthol methyl ether, and menthyl pyrrolidone carboxylate among others. These and other suitable cooling agents are further described in the following U.S. patents, all of which are incorporated in their entirety by reference hereto: U.S. Pat. Nos. 4,230,688; 4,032,661; 4,459,425; 4,136,163; 5,266,592; 6,627,233.

In some embodiments, warming components may be selected from a wide variety of compounds known to provide the sensory signal of warming to the user. These compounds offer the perceived sensation of warmth, particularly in the oral cavity, and often enhance the perception of flavors, sweeteners and other organoleptic components. In some embodiments, useful warming compounds can include vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamyleather, vanillyl alcohol n-hexyleather, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, ethanol, isopropyl alcohol, iso-amylalcohol, benzyl alcohol, glycerine, and combinations thereof.

In some embodiments, a tingling sensation can be provided. One such tingling sensation is provided by adding jambu, oleoresin, or spilanthol to some examples. In some embodiments, alkylamides extracted from materials such as jambu or sanshool can be included. Additionally, in some embodiments, a sensation is created due to effervescence. Such effervescence is created by combining an alkaline material with an acidic material. In some embodiments, an alkaline material can include alkali metal carbonates, alkali metal bicarbonates, alkaline earth metal carbonates, alkaline earth metal bicarbonates and mixtures thereof. In some embodiments, an acidic material can include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof. Examples of “tingling” type sensates can be found in U.S. Pat. No. 6,780,443, the entire contents of which are incorporated herein by reference for all purposes.

Sensate components may also be referred to as “trigeminal stimulants” such as those disclosed in U.S. Patent Application No. 205/0202118, which is incorporated herein by reference. Trigeminal stimulants are defined as an orally consumed product or agent that stimulates the trigeminal nerve. Examples of cooling agents which are trigeminal stimulants include menthol, WS-3, N-substituted p-menthane carboxamide, acyclic carboxamides including WS-23, methyl succinate, menthone glycerol ketals, bulk sweeteners such as xylitol, erythritol, dextrose, and sorbitol, and combinations thereof. Trigeminal stimulants can also include flavors, tingling agents, Jambu extract, vanillyl alkyl ethers, such as vanillyl n-butyl ether, spilanthol, Echinacea extract, Northern Prickly Ash extract, capsaicin, capsicum oleoresin, red pepper oleoresin, black pepper oleoresin, piperine, ginger oleoresin, gingerol, shoagol, cinnamon oleoresin, cassia oleoresin, cinnamic aldehyde, eugenol, cyclic acetal of vanillin and menthol glycerin ether, unsaturated amides, and combinations thereof.

### Breath Freshening Agents

Breath fresheners can include essential oils as well as various aldehydes, alcohols, and similar materials. In some embodiments, essential oils can include oils of spearmint, peppermint, wintergreen, sassafras, chlorophyll, citral, geraniol, cardamom, clove, sage, carvacrol, eucalyptus, cardamom, magnolia bark extract, marjoram, cinnamon, lemon, lime, grapefruit, and orange. In some embodiments, aldehydes such as cinnamic aldehyde and salicylaldehyde can be used. Additionally, chemicals such as menthol, carvone, iso-garrigol, and anethole can function as breath fresheners. Of these, the most commonly employed are oils of peppermint, spearmint and chlorophyll.

In addition to essential oils and chemicals derived from them, in some embodiments breath fresheners can include but are not limited to zinc citrate, zinc acetate, zinc fluoride, zinc ammonium sulfate, zinc bromide, zinc iodide, zinc chloride, zinc nitrate, zinc fluorosilicate, zinc gluconate, zinc tartarate, zinc succinate, zinc formate, zinc chromate, zinc phenol sulfonate, zinc dithionate, zinc sulfate, silver nitrate, zinc salicylate, zinc glycerophosphate, copper nitrate, chlorophyll, copper chlorophyll, chlorophyllin, hydrogenated cottonseed oil, chlorine dioxide, beta cyclodextrin, zeolite, silica-based materials, carbon-based materials, enzymes such as laccase, and combinations thereof. In some embodiments, the release profiles of probiotics can be managed for a gum including, but not limited to lactic acid producing microorganisms such as Bacillus coagulans, Bacillus subtilis, Bacillus laterosporus, Bacillus laevolacticus, Sporolactobacillus inulinus, Lactobacillus acidophilus, Lactobacillus curvatus, Lactobacillus plantarum, Lactobacillus jenseni, Lactobacillus casei, Lactobacillus fermentum, Lactococcus lactis, Pedioccocus acidilacti, Pedioccocus pentosaceus, Pedioccocus urinae, Leuconostoc mesenteroides, Bacillus coagulans, Bacillus subtilis, Bacillus laterosporus, Bacillus laevolacticus, Sporolactobacillus inulinus and mixtures thereof. Breath fresheners are also known by the following trade names: Retsyn,™ Actizol,™ and Nutrazin.™ Examples of malodor-controlling compositions are also included in U.S. Pat. No. 5,300,305 to Stapler et al. and in U.S. Patent Application Publication Nos. 2003/0215417 and 2004/0081713 which are incorporated in their entirety herein by reference for all purposes.

### Dental Care Agents

Dental care ingredients (also known as oral care ingredients) may include but are not limited to tooth whiteners, stain removers, oral cleaning, bleaching agents, desensitizing agents, dental remineralization agents, antibacterial agents, anticaries agents, plaque acid buffering agents, surfactants and anticalculus agents. Non-limiting examples of such ingredients can include, hydrolytic agents including proteolytic enzymes, abrasives such as hydrated silica, calcium carbonate, sodium bicarbonate and alumina, other active stain-removing components such as surface-active agents, including, but not limited to anionic surfactants such as sodium stearate, sodium palminate, sulfated butyl oleate, sodium oleate, salts of fumaric acid, glycerol, hydroxylated lecithin, sodium lauryl sulfate and chelators such as polyphosphates, which are typically employed as tartar control ingredients. In some embodiments, dental care ingredients can also include tetrasodium pyrophosphate and sodium tri-polyphosphate, sodium bicarbonate, sodium acid pyrophosphate, sodium tripolyphosphate, xylitol, sodium hexametaphosphate.

In some embodiments, peroxides such as carbamide peroxide, calcium peroxide, magnesium peroxide, sodium peroxide, hydrogen peroxide, and peroxydiphospate are included. In some embodiments, potassium nitrate and potassium citrate are included. Other examples can include casein glycomacropeptide, calcium casein peptone-calcium phosphate, casein phosphopeptides, casein phosphopeptide-amorphous calcium phosphate (CPP-ACP), and amorphous calcium phosphate. Still other examples can include papaine, krillase, pepsin, trypsin, lysozyme, dextranase, mutanase, glycoamylase, amylase, glucose oxidase, and combinations thereof.

Further examples can include surfactants such as sodium stearate, sodium ricinoleate, and sodium lauryl sulfate surfactants for use in some embodiments to achieve increased prophylactic action and to render the dental care ingredients more cosmetically acceptable. Surfactants can preferably be detersive materials which impart to the composition detersive and foaming properties. Suitable examples of surfactants are water-soluble salts of higher fatty acid monoglyceride monosulfates, such as the sodium salt of the monosulfated monoglyceride of hydgrogenated coconut oil fatty acids, higher alkyl sulfates such as sodium lauryl sulfate, alkyl aryl sulfonates such as sodium dodecyl benzene sulfonate, higher alkyl sulfoacetates, sodium lauryl sulfoacetate, higher fatty acid esters of 1,2-dihydroxy propane sulfonate, and the substantially saturated higher aliphatic acyl amides of lower aliphatic amino carboxylic acid compounds, such as those having 12 to 16 carbons in the fatty acid, alkyl or acyl radicals, and the like. Examples of the last mentioned amides are N-lauroyl sarcosine, and the sodium, potassium, and ethanolamine salts of N-lauroyl, N-myristoyl, or N-palmitoyl sarcosine.

In addition to surfactants, dental care ingredients can include antibacterial agents such as, but not limited to, triclosan, chlorhexidine, zinc citrate, silver nitrate, copper, limonene, and cetyl pyridinium chloride. In some embodiments, additional anticaries agents can include fluoride ions or fluorine-providing components such as inorganic fluoride salts. In some embodiments, soluble alkali metal salts, for example, sodium fluoride, potassium fluoride, sodium fluorosilicate, ammonium fluorosilicate, sodium monofluorophosphate, as well as tin fluorides, such as stannous fluoride and stannous chloride can be included. In some embodiments, a fluorine-containing compound having a beneficial effect on the care and hygiene of the oral cavity, e.g., diminution of enamel solubility in acid and protection of the teeth against decay may also be included as an ingredient. Examples thereof include sodium fluoride, stannous fluoride, potassium fluoride, potassium stannous fluoride (SnF.sub.2-KF), sodium hexafluorostannate, stannous chlorofluoride, sodium fluorozirconate, and sodium monofluorophosphate. In some embodiments, urea is included.

Further examples are included in the following U.S. patents and U.S. published patent applications, the contents of all of which are incorporated in their entirety herein by reference for all purposes: U.S. Pat. No. 5,997,154 to Reynolds, U.S. Pat. No. 5,378,131 to Greenberg, U.S. Pat. No. 6,846,500 to Luo et al., U.S. Pat. No. 6,733,818 to Luo et al., U.S. Pat. No. 6,696,044 to Luo et al., U.S. Pat. No. 6,685,916 to Holme et al., U.S. Pat. No. 6,485,739 to Luo et al., U.S. Pat. No. 6,479,071 to Holme et al., U.S. Pat. No. 6,471,945 to Luo et al., U.S. Patent Publication Nos. 20050025721 to Holme et al., 2005008732 to Gebreselassie et al., and 20040136928 to Holme et al.

### Active Agents

Actives generally refer to those ingredients that are included in a chewing gum composition for the desired end benefit they provide to the user. In some embodiments, actives can include medicaments, nutrients, nutraceuticals, herbals, nutritional supplements, pharmaceuticals, drugs, and the like and combinations thereof.

Examples of useful drugs include ace-inhibitors, antianginal drugs, anti-arrhythmias, anti-asthmatics, anti-cholesterolemics, analgesics, anesthetics, anti-convulsants, anti-depressants, anti-diabetic agents, anti-diarrhea preparations, antidotes, anti-histamines, anti-hypertensive drugs, anti-inflammatory agents, anti-lipid agents, anti-manics, anti-nauseants, anti-stroke agents, anti-thyroid preparations, anti-tumor drugs, anti-viral agents, acne drugs, alkaloids, amino acid preparations, anti-tussives, anti-uricemic drugs, anti-viral drugs, anabolic preparations, systemic and non-systemic anti-infective agents, anti-neoplastics, anti-parkinsonian agents, anti-rheumatic agents, appetite stimulants, biological response modifiers, blood modifiers, bone metabolism regulators, cardiovascular agents, central nervous system stimulates, cholinesterase inhibitors, contraceptives, decongestants, dietary supplements, dopamine receptor agonists, endometriosis management agents, enzymes, erectile dysfunction therapies such as sildenafil citrate, which is currently marketed as Viagra™, fertility agents, gastrointestinal agents, homeopathic remedies, hormones, hypercalcemia and hypocalcemia management agents, immunomodulators, immunosuppressives, migraine preparations, motion sickness treatments, muscle relaxants, obesity management agents, osteoporosis preparations, oxytocics, parasympatholytics, parasympathomimetics, prostaglandins, psychotherapeutic agents, respiratory agents, sedatives, smoking cessation aids such as bromocryptine or nicotine, sympatholytics, tremor preparations, urinary tract agents, vasodilators, laxatives, antacids, ion exchange resins, anti-pyretics, appetite suppressants, expectorants, anti-anxiety agents, anti-ulcer agents, anti-inflammatory substances, coronary dilators, cerebral dilators, peripheral vasodilators, psycho-tropics, stimulants, anti-hypertensive drugs, vasoconstrictors, migraine treatments, antibiotics, tranquilizers, anti-psychotics, anti-tumor drugs, anti-coagulants, anti-thrombotic drugs, hypnotics, anti-emetics, anti-nauseants, anti-convulsants, neuromuscular drugs, hyper- and hypo-glycemic agents, thyroid and anti-thyroid preparations, diuretics, anti-spasmodics, terine relaxants, anti-obesity drugs, erythropoietic drugs, anti-asthmatics, cough suppressants, mucolytics, DNA and genetic modifying drugs, and combinations thereof.

Examples of active ingredients contemplated for use in the present invention can include antacids, H2-antagonists, and analgesics. For example, antacid dosages can be prepared using the ingredients calcium carbonate alone or in combination with magnesium hydroxide, and/or aluminum hydroxide. Moreover, antacids can be used in combination with H2-antagonists.

Analgesics include opiates and opiate derivatives, such as Oxycontin™, ibuprofen, aspirin, acetaminophen, and combinations thereof that may optionally include caffeine.

Other drug active ingredients for use in embodiments can include anti-diarrheals such as Immodium™ AD, anti-histamines, anti-tussives, decongestants, vitamins, and breath fresheners. Also contemplated for use herein are anxiolytics such as Xanax™; anti-psychotics such as Clozaril™ and Haldol™, non-steroidal anti-inflammatories (NSAID's) such as ibuprofen, naproxen sodium, Voltaren™ and Lodine™, anti-histamines such as Claritin™, Hismanal™, Relafen™, and Tavist™; anti-emetics such as Kytril™ and Cesamet™; bronchodilators such as Bentolin™, Proventil™; anti-depressants such as Prozac™, Zoloft™, and Paxil™; anti-migraines such as Imigra™, ACE-inhibitors such as Vasotec™, Capoten™ and Zestril™; anti-Alzheimer's agents, such as Nicergoline™; and CaH-antagonists such as Procardia™, Adalat™, and Calan™.

The popular H2-antagonists which are contemplated for use in the present invention include cimetidine, ranitidine hydrochloride, famotidine, nizatidien, ebrotidine, mifentidine, roxatidine, pisatidine and aceroxatidine.

Active antacid ingredients can include, but are not limited to, the following: aluminum hydroxide, dihydroxyaluminum aminoacetate, aminoacetic acid, aluminum phosphate, dihydroxyaluminum sodium carbonate, bicarbonate, bismuth aluminate, bismuth carbonate, bismuth subcarbonate, bismuth subgallate, bismuth subnitrate, bismuth subsilysilate, calcium carbonate, calcium phosphate, citrate ion (acid or salt), amino acetic acid, hydrate magnesium aluminate sulfate, magaldrate, magnesium aluminosilicate, magnesium carbonate, magnesium glycinate, magnesium hydroxide, magnesium oxide, magnesium trisilicate, milk solids, aluminum mono-ordibasic calcium phosphate, tricalcium phosphate, potassium bicarbonate, sodium tartrate, sodium bicarbonate, magnesium aluminosilicates, tartaric acids and salts.

A variety of nutritional supplements may also be used as active ingredients including virtually any vitamin or mineral. For example, vitamin A, vitamin C, vitamin D, vitamin E, vitamin K, vitamin B₆, vitamin B₁₂, thiamine, riboflavin, biotin, folic acid, niacin, pantothenic acid, sodium, potassium, calcium, magnesium, phosphorus, sulfur, chlorine, iron, copper, iodine, zinc, selenium, manganese, choline, chromium, molybdenum, fluorine, cobalt and combinations thereof, may be used.

Examples of nutritional supplements that can be used as active ingredients are set forth in U.S. Patent Application Publication Nos. 2003/0157213 A1, 2003/0206993 and 2003/0099741 A1 which are incorporated in their entirety herein by reference for all purposes.

Various herbals may also be used as active ingredients such as those with various medicinal or dietary supplement properties. Herbals are generally aromatic plants or plant parts and or extracts thereof that can be used medicinally or for flavoring. Suitable herbals can be used singly or in various mixtures. Commonly used herbs include Echinacea, Goldenseal, Calendula, Rosemary, Thyme, Kava Kava, Aloe, Blood Root, Grapefruit Seed Extract, Black Cohosh, Ginseng, Guarana, Cranberry, Gingko Biloba, St. John's Wort, Evening Primrose Oil, Yohimbe Bark, Green Tea, Ma Huang, Maca, Bilberry, Lutein, and combinations thereof.

### Effervescing System Agents

An effervescent system may include one or more edible acids and one or more edible alkaline materials. The edible acid(s) and the edible alkaline material(s) may react together to generate effervescence.

In some embodiments, the alkaline material(s) may be selected from, but is not limited to, alkali metal carbonates, alkali metal bicarbonates, alkaline earth metal carbonates, alkaline earth metal bicarbonates, and combinations thereof. The edible acid(s) may be selected from, but is not limited to, citric acid, phosphoric acid, tartaric acid, malic acid, ascorbic acid, and combinations thereof. In some embodiments, an effervescing system may include one or more other ingredients such as, for example, carbon dioxide, oral care ingredients, flavorants, etc.

For examples of use of an effervescing system in a chewing gum, refer to U.S. Provisional Patent No. 60/618,222 filed Oct. 13, 2004, and entitled “Effervescent Pressed Gum Tablet Compositions,” the contents of which are incorporated herein by reference for all purposes. Other examples can be found in U.S. Pat. No. 6,235,318, the contents of which are incorporated herein by reference for all purposes.

### Appetite Suppressor Agents

Appetite suppressors can be ingredients such as fiber and protein that function to depress the desire to consume food. Appetite suppressors can also include benzphetamine, diethylpropion, mazindol, phendimetrazine, phentermine, hoodia (P57), Olibra,™ ephedra, caffeine and combinations thereof. Appetite suppressors are also known by the following trade names: Adipex,™ Adipost,™ Bontril™ PDM, Bontril™ Slow Release, Didrex,™ Fastin,™ Ionamin,™ Mazanor,™ Melfiat,™ Obenix,™ Phendiet,™ Phendiet-105,™ Phentercot,™ Phentride,™ Plegine,™ Prelu-2,™ Pro-Fast,™ PT 105,™ Sanorex,™ Tenuate,™ Sanorex,™ Tenuate,™ Tenuate Dospan,™ Tepanil Ten-Tab,™ Teramine,™ and Zantryl.™ These and other suitable appetite suppressors are further described in the following U.S. patents, all of which are incorporated in their entirety by reference hereto: U.S. Pat. No. 6,838,431 to Portman, U.S. Pat. No. 6,716,815 to Portman, U.S. Pat. No. 6,558,690 to Portman, U.S. Pat. No. 6,468,962 to Portman, U.S. Pat. No. 6,436,899 to Portman.

### Potentiator Agents

Potentiators can consist of materials that may intensify, supplement, modify or enhance the taste and/or aroma perception of an original material without introducing a characteristic taste and/or aroma perception of their own. In some embodiments, potentiators designed to intensify, supplement, modify, or enhance the perception of flavor, sweetness, tartness, umami, kokumi, saltiness and combinations thereof can be included.

In some embodiments, examples of suitable potentiators, also known as taste potentiators include, but are not limited to, neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), sugar acids, potassium chloride, sodium acid sulfate, hydrolyzed vegetable proteins, hydrolyzed animal proteins, yeast extracts, adenosine monophosphate (AMP), glutathione, nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt, sugar beet extract (alcoholic extract), sugarcane leaf essence (alcoholic extract), curculin, strogin, mabinlin, gymnemic acid, 3-hydrobenzoic acid, 2,4-dihydrobenzoic acid, citrus aurantium, vanilla oleoresin, sugarcane leaf essence, maltol, ethyl maltol, vanillin, licorice glycyrrhizinates, compounds that respond to G-protein coupled receptors (T2Rs and T1Rs) and taste potentiator compositions that impart kokumi, as disclosed in U.S. Pat. No. 5,679,397 to Kuroda et al., which is incorporated in its entirety herein by reference. “Kokumi” refers to materials that impart “mouthfulness” and “good body”.

Sweetener potentiators, which are a type of taste potentiator, enhance the taste of sweetness. In some embodiments, exemplary sweetener potentiators include, but are not limited to, monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, sugar beet extract, neotame, thaumatin, neohesperidin dihydrochalcone, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs) and combinations thereof.

Additional examples of potentiators for the enhancement of salt taste include acidic peptides, such as those disclosed in U.S. Pat. No. 6,974,597, herein incorporated by reference. Acidic peptides include peptides having a larger number of acidic amino acids, such as aspartic acid and glutamic acid, than basic amino acids, such as lysine, arginine and histidine. The acidic peptides are obtained by peptide synthesis or by subjecting proteins to hydrolysis using endopeptidase, and if necessary, to deamidation. Suitable proteins for use in the production of the acidic peptides or the peptides obtained by subjecting a protein to hydrolysis and deamidation include plant proteins, (e.g. wheat gluten, corn protein (e.g., zein and gluten meal), soybean protein isolate), animal proteins (e.g., milk proteins such as milk casein and milk whey protein, muscle proteins such as meat protein and fish meat protein, egg white protein and collagen), and microbial proteins (e.g., microbial cell protein and polypeptides produced by microorganisms).

The sensation of warning or cooling effects may also be prolonged with the use of a hydrophobic sweetener as described in U.S. Patent Application Publication 2003/0072842 A1 which is incorporated in its entirety herein by reference. For example, such hydrophobic sweeteners include those of the formulae I-XI as set forth below:

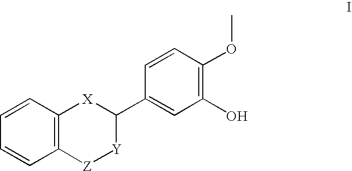

wherein X, Y and Z are selected from the group consisting of CH₂, O and S;

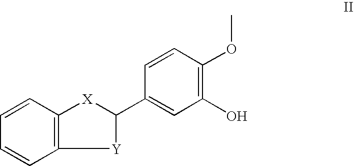

wherein X and Y are selected from the group consisting of S and O;

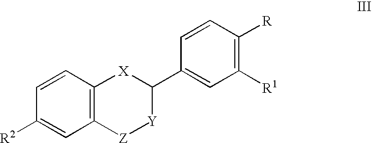

wherein X is S or O; Y is O or CH₂; Z is CH₂, SO₂ or S; R is OCH₃, OH or H; R¹ is SH or OH and R² is H or OH;

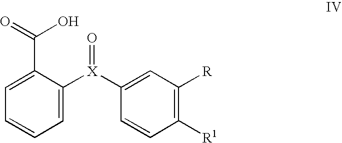

wherein X is C or S; R is OH or H and R¹ is OCH₃ or OH;

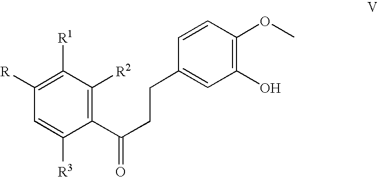

wherein R, R² and R³ are OH or H and R¹ is H or COOH;

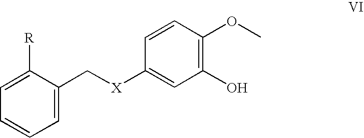

wherein X is O or CH₂ and R is COOH or H;

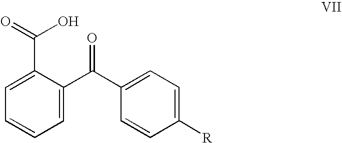

wherein R is CH₃CH₂, OH, N (CH3)₂ or Cl;

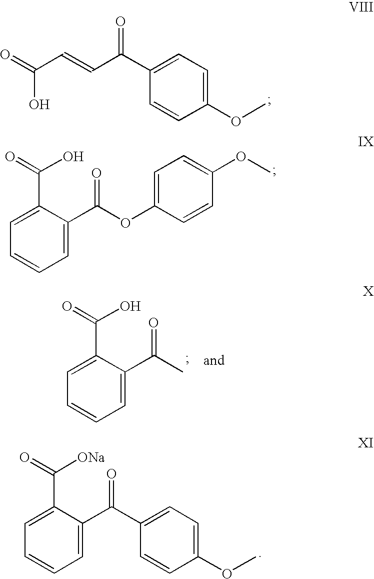

Perillartine may also be added as described in U.S. Pat. No. 6,159,509 also incorporated in its entirety herein by reference.

### Food Acid Agents

Acids can include, but are not limited to acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof.

### Micronutrient Agents

Micronutrients can include materials that have an impact on the nutritional well being of an organism even though the quantity required by the organism to have the desired effect is small relative to macronutrients such as protein; carbohydrate, and fat. Micronutrients can include, but are not limited to vitamins, minerals, enzymes, phytochemicals, antioxidants, and combinations thereof.

In some embodiments, vitamins can include fat soluble vitamins such as vitamin A, vitamin D, vitamin E, and vitamin K and combinations thereof. In some embodiments, vitamins can include water soluble vitamins such as vitamin C (ascorbic acid), the B vitamins (thiamine or B₁, riboflavoin or B₂, niacin or B₃, pyridoxine or B₆, folic acid or B₉, cyanocobalimin or B₁₂, pantothenic acid, biotin), and combinations thereof.

In some embodiments minerals can include but are not limited to sodium, magnesium, chromium, iodine, iron, manganese, calcium, copper, fluoride, potassium, phosphorous, molybdenum, selenium, zinc, and combinations thereof.

In some embodiments micronutrients can include but are not limited to L-carnitine, choline, coenzyme Q10, alpha-lipoic acid, omega-3-fatty acids, pepsin, phytase, trypsin, lipases, proteases, cellulases, and combinations thereof.

Antioxidants can include materials that scavenge free radicals. In some embodiments, antioxidants can include but are not limited to ascorbic acid, citric acid, rosemary oil, vitamin A, vitamin E, vitamin E phosphate, tocopherols, di-alpha-tocopheryl phosphate, tocotrienols, alpha lipoic acid, dihydrolipoic acid, xanthophylls, beta cryptoxanthin, lycopene, lutein, zeaxanthin, astaxanthin, beta-carotene, carotenes, mixed carotenoids, polyphenols, flavonoids, and combinations thereof.

In some embodiments phytochemicals can include but are not limited to cartotenoids, chlorophyll, chlorophyllin, fiber, flavanoids, anthocyanins, cyaniding, delphinidin, malvidin, pelargonidin, peonidin, petunidin, flavanols, catechin, epicatechin, epigallocatechin, epigallocatechingallate, theaflavins, thearubigins, proanthocyanins, flavanols, quercetin, kaempferol, myricetin, isorhamnetin, flavononeshesperetin, naringenin, eriodictyol, tangeretin, flavones, apigenin, luteolin, lignans, phytoestrogens, resveratrol, isoflavones, daidzein, genistein, glycitein, soy isoflavones, and combinations thereof.

### Mouth Moistening Agents

Mouth moisteners can include, but are not limited to, saliva stimulators such as acids and salts and combinations thereof. In some embodiments, acids can include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof.

Mouth moisteners can also include hydrocolloid materials that hydrate and may adhere to oral surface to provide a sensation of mouth moistening. Hydrocolloid materials can include naturally occurring materials such as plant exudates, seed gums, and seaweed extracts or they can be chemically modified materials such as cellulose, starch, or natural gum derivatives. In some embodiments, hydrocolloid materials can include pectin, gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, bacterial gums, and combinations thereof. Additionally, in some embodiments, modified natural gums such as propylene glycol alginate, carboxymethyl locust bean gum, low methoxyl pectin, and their combinations can be included. In some embodiments, modified celluloses can be included such as microcrystalline cellulose, carboxymethylcellulose (CMC), methylcellulose (MC), hydroxypropylmethylcellulose (HPCM), and hydroxypropylcellulose (MPC), and combinations thereof.

Similarly, humectants which can provide a perception of mouth hydration can be included. Such humectants can include, but are not limited to glycerol, sorbitol, polyethylene glycol, erythritol, and xylitol. Additionally, in some embodiments, fats can provide a perception of mouth moistening. Such fats can include medium chain triglycerides, vegetable oils, fish oils, mineral oils, and combinations thereof.

### Throat Care Agents

Throat soothing ingredients can include analgesics, anesthetics, demulcents, antiseptic, and combinations thereof. In some embodiments, analgesics/anesthetics can include menthol, phenol, hexylresorcinol, benzocaine, dyclonine hydrochloride, benzyl alcohol, salicyl alcohol, and combinations thereof. In some embodiments, demulcents can include but are not limited to slippery elm bark, pectin, gelatin, and combinations thereof. In some embodiments, antiseptic ingredients can include cetylpyridinium chloride, domiphen bromide, dequalinium chloride, and combinations thereof.

In some embodiments, antitussive ingredients such as chlophedianol hydrochloride, codeine, codeine phosphate, codeine sulfate, dextromethorphan, dextromethorphan hydrobromide, diphenhydramine citrate, and diphenhydramine hydrochloride, and combinations thereof can be included.

In some embodiments, throat soothing agents such as honey, propolis, aloe vera, glycerine, menthol and combinations thereof can be included. In still other embodiments, cough suppressants can be included. Such cough suppressants can fall into two groups: those that alter the consistency or production of phlegm such as mucolytics and expectorants; and those that suppress the coughing reflex such as codeine (narcotic cough suppressants), antihistamines, dextromethorphan and isoproterenol (non-narcotic cough suppressants). In some embodiments, ingredients from either or both groups can be included.

In still other embodiments, antitussives can include, but are not limited to, the group consisting of codeine, dextromethorphan, dextrorphan, diphenhydramine, hydrocodone, noscapine, oxycodone, pentoxyverine and combinations thereof. In some embodiments, antihistamines can include, but are not limited to, acrivastine, azatadine, brompheniramine, chlorpheniramine, clemastine, cyproheptadine, dexbrompheniramine, dimenhydrinate, diphenhydramine, doxylamine, hydroxyzine, meclizine, phenindamine, phenyltoloxanine, promethazine, pyrilamine, tripelennamine, triprolidine and combinations thereof. In some embodiments, non-sedating antihistamines can include, but are not limited to, astemizole, cetirizine, ebastine, fexofenadine, loratidine, terfenadine, and combinations thereof.

In some embodiments, expectorants can include, but are not limited to, ammonium chloride, guaifenesin, ipecac fluid extract, potassium iodide and combinations thereof. In some embodiments, mucolytics can include, but are not limited to, acetylcycsteine, ambroxol, bromhexine and combinations thereof. In some embodiments, analgesic, antipyretic and anti-inflammatory agents can include, but are not limited to, acetaminophen, aspirin, diclofenac, diflunisal, etodolac, fenoprofen, flurbiprofen, ibuprofen, ketoprofen, ketorolac, nabumetone, naproxen, piroxicam, caffeine and mixtures thereof. In some embodiments, local anesthetics can include, but are not limited to, lidocaine, benzocaine, phenol, dyclonine, benzonotate and mixtures thereof.

In some embodiments nasal decongestants and ingredients that provide the perception of nasal clearing can be included. In some embodiments, nasal decongestants can include but are not limited to phenylpropanolamine, pseudoephedrine, ephedrine, phenylephrine, oxymetazoline, and combinations thereof. In some embodiments ingredients that provide a perception of nasal clearing can include but are not limited to menthol, camphor, borneol, ephedrine, eucalyptus oil, peppermint oil, methyl salicylate, bornyl acetate, lavender oil, wasabi extracts, horseradish extracts, and combinations thereof. In some embodiments, a perception of nasal clearing can be provided by odoriferous essential oils, extracts from woods, gums, flowers and other botanicals, resins, animal secretions, and synthetic aromatic materials.

In some embodiments, one or more colors can be included. As classified by the United States Food, Drug, and Cosmetic Act (21 C.F.R. 73), colors can include exempt from certification colors (sometimes referred to as natural even though they can be synthetically manufactured) and certified colors (sometimes referred to as artificial), or combinations thereof. In some embodiments, exempt from certification or natural colors can include, but are not limited to annatto extract, (E160b), bixin, norbixin, astaxanthin, dehydrated beets (beet powder), beetroot red/betanin (E162), ultramarine blue, canthaxanthin (E161g), crptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120); carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthoocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), and combinations thereof.

In some embodiments, certified colors can include, but are not limited to, FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), and combinations thereof. In some embodiments, certified colors can include FD&C aluminum lakes. These consist of the aluminum salts of FD&C dyes extended on an insoluble substrate of alumina hydrate. Additionally, in some embodiments, certified colors can be included as calcium salts.

### Multiple Agents

In some embodiments, a chewing gum composition may include two or more ingredients for which managed release from the chewing gum during consumption is desired. In some embodiments, the ingredients may be encapsulated or otherwise included separately in different delivery systems. Alternatively, in some embodiments the ingredients may be encapsulated or otherwise included in the same delivery system. As another possibility, one or more of the ingredients may be free (e.g., unencapsulated) while one or more other ingredients may be encapsulated.

A chewing gum composition may include a group of ingredients for which managed release of the group during consumption of the chewing gum composition is desired. Groups of two or more ingredients for which managed release from a chewing gum composition during consumption thereof may be desired include, but are riot limited to: color and flavor, multiple flavors, multiple colors, cooling agent and flavor, warming agent and flavor, cooling agent and warming agent, cooling agent and high intensity sweetener, warming agent and high intensity sweetener, multiple cooling agents (e.g., WS-3 and WS-3, WS-3 and menthyl succinate), menthol and one or more cooling agents, menthol and one or more warming agents, multiple warming agents, high intensity sweetener(s) and tooth whitening active(s), high intensity sweetener(s) and breath freshening active(s), an ingredient with some bitterness and a bitterness suppressor for the ingredient, multiple high intensity, sweeteners (e.g., ace-k and aspartame), multiple tooth whitening actives (e.g., an abrasive ingredient and an antimicrobial ingredient, a peroxide and a nitrate, a warming agent and a polyol, a cooling agent and a polyol, multiple polyols, a warming agent and micronutrient, a cooling agent and a micronutrient, a warming agent and a mouth moistening agent, a cooling agent and a mouth moistening agent, a warming agent and a throat care agent, a cooling agent and a throat care agent, a warming agent and a food acid, a cooling agent and food acid, a warming agent and an emulsifier/surfactant, a cooling agent and an emulsifier/surfactant, a warming agent and a color, a cooling agent and a color, a warming agent and a flavor potentiator, a cooling agent and a flavor potentiator, a warming agent with sweetness potentiator, a cooling agent with a sweetness potentiator, a warming agent and an appetite suppressant, a cooling agent and an appetite suppressant, a high intensity sweetener and a flavor, a cooling agent and a teeth whitening agent, a warming agent and a teeth whitening agent, a warming agent and breath freshening agent, a cooling agent and a breath freshening agent, a cooling agent and an effervescing system, a warming agent and an effervescing system, a warming agent and an antimicrobial agent, a cooling agent and an antimicrobial agent, multiple anticalculus ingredients, multiple remineralization ingredients, multiple surfactants, remineralization ingredients with demineralization ingredients, acidic ingredients with acid buffering ingredients, anticalculus ingredients with antibacterial ingredients, remineralization ingredients with anticalculus ingredients, anticalculus ingredients with remineralization ingredients with antibacterial ingredients, surfactant ingredients with anticalculus ingredients, surfactant ingredients with antibacterial ingredients, surfactant ingredients with remineralization ingredients, surfactants with anticalculus ingredients with antibacterial ingredients, multiple types of vitamins or minerals, multiple micronutrients, multiple acids, multiple antimicrobial ingredients, multiple breath freshening ingredients, breath freshening ingredients and antimicrobial ingredients, multiple appetite suppressors, acids and bases that react to effervesce, a bitter compound with a high intensity sweetener, a cooling agent and an appetite suppressant, a warming agent and an appetite suppressant, a high intensity sweetener and an appetite suppressant, a high intensity sweetener with an acid, a probiotic ingredient and a prebiotic ingredient, a vitamin and a mineral, a metabolic enhancement ingredient with a macronutrient, a metabolic enhancement ingredient with a micronutrient, an enzyme with a substrate, a high intensity sweetener with a sweetness potentiator, a cooling compound with a cooling potentiator, a flavor with a flavor potentiator, a warming compound with a warming potentiator, a flavor with salt, a high intensity sweetener with salt, an acid with salt, a cooling compound with salt, a warming compound with salt, a flavor with a surfactant, an astringent compound with an ingredient to provide a sensation of hydration, etc. In some embodiments, the multiple ingredients may be part of the same delivery system or may be part of different delivery systems. Different delivery systems may use the same or different encapsulating materials.

Typically, encapsulation of the multiple ingredients will result in a delay in the release of the predominant amount of the multiple ingredients during consumption of a chewing gum composition that includes the encapsulated multiple ingredients (e.g., as part of a delivery system added as an ingredient to the chewing gum). This may be particularly helpful in situations wherein separate encapsulation of the ingredients may cause them to release with different release profiles. For example, different high intensity sweeteners may have different release profiles because they have different water solubilities or differences in other characteristics. Encapsulating them together may cause them to release more simultaneously.

In some embodiments, the release profile of the multiple ingredients can be managed for a gum by managing various characteristics of the multiple ingredients, the delivery system containing the multiple ingredients, and/or the chewing gum containing the delivery system and/or how the delivery system is made in a manner as previously discussed above.

The additional components, as described above, may be used in one or more regions or layers of the gum composition, such as in the center-fill, the gum region or the coating as desired.

The additional components may be added to one or more regions or layers of the center-fill gum in their encapsulated and/or unencapsulated forms, as well as in combination with any of the other optional components. For instance, a single component may be added to a center-fill gum in its encapsulated and unencapsulated forms. The two different forms of the component may be added to the same or different region of the center-fill gum in the same or different amounts.

In some embodiments, a single component may be added in two or more different encapsulated forms. On particular, two or more different encapsulating materials, such as different polymers, may be used to encapsulate two or more separate portions of the component. The different encapsulated forms of the same component may be added to the same or different region of the center-filled product in the same or different amounts. Further, in some embodiments, an unencapsulated form of the same component may be added in combination with the two or more different encapsulated forms. The unencapsulated form of the component may be added to any region of the center-filled product in the same or different amount from the encapsulated forms. Moreover, some embodiments may add an unencapsulated form of a similar component in combination with the two or more different encapsulated forms. For instance, two encapsulated forms of a single sweetener may be used in combination with an unencapsulated form of a different sweetener.

In some embodiments, combinations of two or more different components may be employed. In some embodiments, at least one of the different components may be encapsulated, while at least one of the other components of the combination may be unencapsulated. The multiple components may be of the same type, e.g., two different sweeteners. Alternatively, the multiple components may be from distinctly different categories, e.g., a sweetener and a warming agent. The different components may be added to the same or different regions of the center-fill gum or confection in the same or different amounts. The amounts of the component in a particular region may be selected depending on how the components may be perceived by the consumer in the different regions, the sensory experience or functional benefit desired to give to the consumer, regulatory issues, resulting bad taste if too much is used in any one region, etc.

Some embodiments may include multiple components each of which is encapsulated. The multiple encapsulated components may be included in the same or different regions of the gum or confection in the same or different amounts. The multiple encapsulated components may be the same type of component or from distinctly different categories.

In some embodiments in which multiple encapsulated components are added to the center-fill gum composition, the multiple components may be encapsulated together or separately. In embodiments in which the multiple components are encapsulated together, the components may be mixed together and encapsulated by a single encapsulating material. In embodiments in which the multiple components are encapsulated separately, the material used to encapsulate the components may be the same or different.

The features and advantages of the present invention are more fully shown by the following examples which are provided for purposes of illustration, and are not to be construed as limiting the invention in any way.

### EXAMPLES

The following Examples are directed to center-fill chewing gum compositions of some embodiments of the present invention. The compositions include an effective amount of triacetin in the gum region and/or an effective amount of lecithin in the center-fill region of the product.

### Example 1

This example shows the effect of triacetin on the stability of center-fill chewing gum products. Two batches of center-filled gum pellets are prepared, the first without triacetin and the second including triacetin in the gum region according to the present invention. The products are prepared using the components and amounts listed in Table 1.

TABLE 1

| | Preparation | Preparation |
|---|---|---|
| | Without | With |
| | Triacetin | Triacetin |
| | Wt. % | Wt. % |
| Gum Region | | |
| Gum Base* | 30-40 | 30-40 |
| Talc | 3-5 | 3-5 |
| Lecithin | 0.1-0.5 | 0.1-0.5 |
| Triacetin** | 0.0 | 0.2-0.4 |
| Hydrogenated Starch Hydrolysate | 7-10 | 4-6 |
| Maltitol Powder | 30-40 | 35-45 |
| Sorbitol Powder | 10-15 | 10-15 |
| Flavor | 2-3 | 2-3 |
| Cooling Agent | 0.1-0.3 | 0.1-0.3 |
| Citric Acid, (Encapsulated) | 0.8-1.0 | 0.8-1.0 |
| Malic Acid, (Encapsulated) | 0.7-1.0 | 0.7-1.0 |
| High intensity sweetener(s) | 0.25-0.5 | 0.25-0.5 |
| High intensity sweetener(s) (Encapsulated) | 2.75-5 | 2.75-5 |
| Center Fill | | |
| Glycerin | 40-60 | 40-60 |
| Hydrogenated Starch Hydrolysate | 40-60 | 40-60 |
| Sucralose | 0.01-0.03 | 0.01-0.03 |
| Xanthan Gum | 0.05-0.075 | 0.05-0.075 |
| Malic Acid | 0.3-0.5 | 0.3-0.5 |
| Citric Acid | 0.75-1.0 | 0.75-1.0 |
| Tartaric Acid | 0.25-0.5 | 0.25-0.5 |
| Flavors | 1.25-1.5 | 1.25-1.5 |
| Coloring | 0.025-0.05 | 0.025-0.05 |
| Coating | | |
| Gum Cores With Center Fill | 70-90 | 70-90 |
| Maltitol | 20-30 | 20-30 |
| Gelatin | 1-1.5 | 1-1.5 |
| Titanium Dioxide | 0.1-0.3 | 0.1-0.3 |
| Flavors | 0.5-1.0 | 0.5-1.0 |
| High intensity sweetener(s) | 0.1-0.3 | 0.1-0.3 |
| Wax | 0.01-0.03 | 0.01-0.03 |

*gum base may include, but is not limited to elastomer, plasticizer and filler
**triacetin may be added to the composition in the gum base or separately by itself

Gum pieces including three regions: liquid-fill, gum region and coating are prepared according to the compositions in Table 1 above with each region according to the corresponding components for compositions with triacetin and without triacetin.

The compositions for the gum regions are prepared by first combining talc, where present, with the gum base under heat at about 85° C. This combination is then mixed with the maltitol or bulking agents, triacetin, lecithin and other polyols for six minutes. The flavor blends which include a pre-mix of the flavors and cooling agents are added and mixed for 1 minute. Finally, the acids and intense sweeteners are added and mixed for 5 minutes.

The liquid-fill composition is then prepared by first preparing a pre-mix of the hydrogenated starch hydrolysate, xanthan gum, and glycerin. This pre-mix is then combined with the colors, flavors, acids, and sweeteners and mixed.

The gum region and liquid-fill compositions are then extruded together and formed into pellets by the process described above at paragraphs [0030] to [0034] above. The products without triacetin are extruded at a temperature of about 50° C., while the products with triacetin are extruded at a temperature of about 38° C. The gum pieces each have a total weight of approximately 2.20 g. In the final gum pieces, the gum region is about 63% by weight, where approximately 50-75% by weight of the total gum region is a layer of the gum composition, the liquid-fill is about 10% by weight, and the coating is about 27% by weight. The pellets without triacetin are approximately 16.5 mm in length, while those with tracetin are approximately 18-18.5 mm in length.

The center-filled pellets that do not include triacetin are seen to shrink after formation. In contrast, the products with triacetin, incorporated into the gum region do not exhibit any significant shrinkage. Accordingly, the inventive products will experience reduced leakage problems, and thus are more stable.

### Example 2

As in Example 1, this example also prepares center-fill gum pellets with and without triacetin. The products are prepared using the components and amounts listed in Table 2.

TABLE 2

| | Preparation | Preparation |
|---|---|---|
| | Without | With |
| | Triacetin | Triacetin |
| | Wt. % | Wt. % |
| Gum region | | |
| Gum Base* | 30-50 | 30-50 |
| Talc | 0 | 2-5 |
| Lecithin | 0.25-1.0 | 0.25-1.0 |
| Triacetin** | 0 | 0.1-1.0 |
| Hydrogenated Starch Hydrolysate | 2-4 | 3-5 |
| Maltitol | 30-50 | 30-50 |
| Sorbitol | 5-20 | 5-20 |
| Flavor(s) | 2-5 | 2-5 |
| Cooling Compound(s) | 0.1-0.5 | 0.1-0.5 |
| Citric Acid | 0.5-1.0 | 0.5-1.0 |
| High intensity sweetener(s) | 0.25-0.75 | 0.25-0.75 |
| High intensity sweetener(s) | 3-5 | 3-5 |
| (encapsulated) | | |
| Center fill region | | |
| Xanthan Gum | 0.1-0.5 | 0.1-0.5 |
| Glycerin | 40-60 | 40-60 |
| Hydrogenated Starch Hydrolysate | 40-60 | 40-60 |
| Flavor(s) | 1-5 | 1-5 |
| High intensity sweetener(s) | 0.05-0.1 | 0.05-0.1 |
| Coating | | |
| Gum Cores | 70-80 | 70-80 |
| Maltitol/Gelatin/Titanium Coating | 20-40 | 20-30 |
| Solution | | |
| Flavor(s) | 0.5-2 | 0.5-2 |
| High intensity sweetener(s) | 0.1-0.5 | 0.1-0.5 |
| Wax | 0.01-0.05 | 0.01-0.05 |

*gum base may include, but is not limited to elastomer, plasticizer and filler
**triacetin may be added to the composition in the gum base or separately by itself

Gum pieces including three regions are prepared as described in Example 1 above.

The final chewing gum pellets without triacetin are approximately 16.5-17 mm in length, while those with triacetin are approximately 18.5-19 mm in length.

The pellets that do not include triacetin are noted to be dry. The pellets with triacetin appear acceptable, without any shrinkage (i.e., the length remains the same).

Example 3

This example prepares additional center-fill gum products including triacetin in the gum region and lecithin in the center-fill composition. Thereby, these products will exhibit greater stability than conventional center-filled gum products. The products are prepared using the components and amounts listed in Table 3.

TABLE 3

| | Composition | Composition | Composition |
|---|---|---|---|
| | A | B | C |
| | Wt. % | Wt. % | Wt. % |
| Gum Region | | | |
| Gum Base* | 30-40 | 35-45 | 45-50 |
| Talc | 3-5 | 3-7 | 5-7 |
| Lecithin | 0.1-0.5 | 0.25-0.5 | 0.25-0.75 |
| Triacetin** | 0.1-0.3 | 0.2-0.5 | 0.2-0.4 |
| Hydrogenated Starch | 7-10 | 5-7 | 4-6 |
| Hydrolysate | | | |
| Polyol(s) | 40-55 | 35-50 | 35-45 |
| Flavor(s) | 2-4 | 1-3 | 2-4 |
| Cooling Agent | 0.1-0.3 | 0.1-0.4 | 0.25-0.5 |
| Citric Acid, (Encapsulated) | 0.8-1.0 | 0.5-0.75 | 0.75-0.9 |
| Malic Acid, (Encapsulated) | 0.5-0.75 | 0.75-1.0 | 1.0-1.25 |
| High intensity sweeteners | 0.25-0.5 | 0.25-0.5 | 0.2-0.4 |
| Encapsulated high intensity | 3-7 | 1-4 | 1-4 |
| sweeteners | | | |
| Center Fill | | | |
| Glycerin | 30-50 | 35-55 | 40-60 |
| Hydrogenated Starch | 40-60 | 35-55 | 30-50 |
| Hydrolysate | | | |
| Sucralose | 0.01-0.03 | 0.02-0.04 | 0.01-0.03 |
| Xanthan Gum | 0.05-0.075 | 0.04-0.06 | 0.06-0.08 |
| Malic Acid | 0.3-0.5 | 0.25-0.5 | 0.5-0.75 |
| Citric Acid | 0.75-1.0 | 0.5-0.75 | 1.0-1.5 |
| Lecithin | 0.03-0.05 | 0.04-0.06 | 0.04-0.06 |
| Tartaric Acid | 0.25-0.5 | 0.5-0.75 | 0.4-0.6 |
| Flavors | 1.25-1.5 | 1.0-1.5 | 1.5-1.75 |
| Coloring | 0.025-0.05 | 0.05-0.075 | 0.025-0.05 |
| Coating | | | |
| Gum Cores With Center Fill | 70-90 | 65-80 | 80-90 |
| Polyol(s) | 20-30 | 25-40 | 10-30 |
| Gelatin | 1-1.5 | 0.5-1.0 | 1-1.25 |
| Titanium Dioxide | 0.1-0.3 | 0.1-0.25 | 0.3-0.5 |
| Flavors | 0.5-1.0 | 0.25-0.75 | 1.0-1.25 |
| High intensity sweetener(s) | 0.1-0.3 | 0.1-0.25 | 0.25-0.5 |
| Wax | 0.01-0.03 | 0.01-0.025 | 0.025-0.05 |

*gum base may include, but is not limited to elastomer, plasticizer and filler
**triacetin may be added to the composition in the gum base or separately by itself

Gum pieces including three regions are prepared as described in Example 1 above.

### Examples 4-9

Examples 4-9 are prepared according to the compositions in Table 4, with the center-filled composition in each example including lecithin. These center-filled chewing gums exhibit better consistency, taste and processing efficiencies due to incorporation of lecithin as compared to similar center-filled gums without lecithin in the center-fill region.

The compositions for the gum regions are prepared by first combining talc with the gum base under heat at about 85° C. This combination is then mixed with the polyols or bulking agents, and lecithin for six minutes. The flavor blends which may include a pre-mix of the flavors and cooling compounds are added and mixed for 1 minute. Finally, sweeteners are added and mixed for 5 minutes.

The liquid-fill composition is then prepared by first preparing a pre-mix of the xanthan gum, lycasin, lecithin and glycerin. This pre-mix is then combined with the colors, flavors, cooling agents, and intense sweeteners and mixed.

The gum region and liquid-fill compositions are then extruded together and formed into pellets by the process described above at paragraphs [0030] to [0034] above. The gum pieces each have a total weight of approximately 2.20 g. In the final gum pieces, the gum region is about 63% by weight, the liquid-fill is about 9-10% by weight, and the coating is about 27-28% by weight. The pellets are approximately 18.5-19 mm in length.

TABLE 4

| | 4 | 5 | 6 | 7 | 8 | 9 |
|---|---|---|---|---|---|---|
| | Wt. % | Wt. % | Wt. % | Wt. % | Wt. % | Wt. % |
| Gum | | | | | | |
| Gum base* | 20-25 | 20-25 | 20-25 | 20-25 | 20-25 | 20-25 |
| Talc | 2-4 | 2-4 | 2-4 | 2-4 | 2-4 | 1.5-3 |
| Lecithin | 0.1-0.3 | 0.1-0.3 | 0.1-0.3 | 0.1-0.3 | 0.1-0.3 | 0.1-0.3 |
| Hydrogenated starch | 1.0-3.0 | 0.5-2.0 | 1.5-4.0 | 1.0-3.0 | 0.5-2.0 | 1.0-3.0 |
| hydrolysate | | | | | | |
| Maltitol | 25-40 | 25-40 | 25-40 | 25-40 | 25-40 | 25-40 |
| Sorbitol | 5-10 | 5-10 | 5-10 | 5-10 | 5-10 | 5-10 |
| Liquid flavoring | 1-2 | .01-0.5 | 1-2 | 1-2 | .01-0.5 | 1-2 |
| Cooling compound(s) | 0.1-0.3 | 1-3 | 0.1-0.3 | 0 | 1-3 | 0.1-0.5 |
| Menthol | 0 | 0 | 0.1-0.5 | 0 | 0 | 0 |
| Masking agent(s) | 0 | 0 | 0.001-0.005 | 0 | 0 | 0 |
| Vanillin | 0.01-0.05 | 0 | 0 | 0 | 0 | 0 |
| High intensity sweetener(s) | | 0.1-0.5 | | 0.1-0.5 | 0.1-0.5 | 0.1-0.5 |
| Encapsulated high intensity | 2-4 | 2-4 | 2-4 | 1-3 | 2-4 | 2-4 |
| sweetener(s) | | | | | | |
| Centerfill | | | | | | |
| Xanthan gum | 0.005-0.01 | 0.005-0.01 | 0.005-0.01 | 0.005-0.01 | 0 | 0 |
| Glycerin | 3-7 | 3-7 | 3-7 | 3-7 | 1-3 | 1-3 |
| Hydrogenated Starch | 3-6 | 3-6 | 3-6 | 3-6 | 2-4 | 2-4 |
| Hydrolysate | | | | | | |
| Lecithin | 0.03-0.05 | 0.04-0.06 | 0.04-0.06 | 0.01-0.03 | 0.02-0.04 | 0.005-0.02 |
| Polyol(s) | 0 | 0 | 0 | 0 | 4-6 | 4-6 |
| Flavor(s) | 0.01-0.04 | 0.001-0.005 | 0.03-0.05 | 0.03-0.05 | 0.001-0.005 | 0.1-0.3 |
| Mint oil | 0.01-0.04 | 0.03-0.06 | 0 | 0 | 0.1-0.5 | 0 |
| Menthol | 0 | 0.1-0.5 | 0.01-0.05 | 0 | 0 | 0 |
| Cooling compound(s) | 0.0001-0.001 | 0.005-0.01 | 0.005-0.01 | 0 | 0.01-0.05 | 0.01-0.05 |
| Masking agent(s) | 0 | 0.001-0.005 | 0.0001-0.0005 | 0 | 0.001-0.005 | 0 |
| Coloring(s) | 0 | 0.0001-0.0005 | 0 | 0 | 0 | 0.0001-0.0005 |
| High intensity sweetener(s) | 0.001-0.005 | 0.05-0.1 | 0.05-0.1 | 0.001-0.005 | 0.05-0.1 | 0.01-0.05 |
| Coating | | | | | | |
| Maltitol | 20-40 | 20-40 | 20-40 | 20-40 | 20-40 | 20-40 |
| Gelatin | 1-3 | 1-3 | 1-3 | 1-3 | 1-3 | 1-3 |
| Titanium dioxide | 0.25-0.5 | 0.25-0.5 | 0.25-0.5 | 0.25-0.5 | 0.25-0.5 | 0.25-0.5 |
| Flavor(s) | 0.25-0.5 | 0.0025-0.005 | 0.0025-0.005 | 0.25-0.5 | 0.0025-0.005 | 0.25-0.5 |
| Mint oil | 0 | 0.25-0.5 | 0.1-0.4 | 0 | 0.1-0.4 | 0 |
| Menthol | 0 | 0.1-0.4 | 0.1-0.4 | 0 | 0 | 0 |
| Cooling Compound(s) | 0.1-0.4 | 0.05-0.1 | 0.075-0.125 | 0 | 0.05-0.1 | 0.025-0.075 |
| Vanillin | 0.005-0.01 | 0 | 0 | 0 | 0 | 0 |
| High Intensity Sweetener(s) | 0.1-0.4 | 0.1-0.4 | 0.1-0.4 | 0.025-0.075 | 0.1-0.4 | 0.025-0.075 |
| Masking agent(s) | 0 | 0.0025-0.005 | 0.0025-0.005 | 0 | 0.001-0.005 | 0 |
| Wax | 0.0075-0.015 | 0.0075-0.015 | 0.0075-0.015 | 0.0075-0.015 | 0.0075-0.015 | 0.0075-0.015 |

*gum base may include, but is not limited to elastomer, plasticizer and filler

### Example 10

Chewing gum compositions are prepared by combining the components as set forth in Examples 10A-10R in Tables 5-7 below.

The gum region is prepared by combining the components as set forth in Examples 10A-10F in Table 5. The amounts included are based on the weight percent of the total gum region composition.

TABLE 5
Gum Region Composition

| | % by weight | | | | | |
|---|---|---|---|---|---|---|
| Component | A | B | C | D | E | F |
| Gum base* | 28-42 | 28-42 | 28-42 | 28-42 | 28-42 | 28-42 |
| Lecithin | 0.25 | 0.25 | 0.05 | 0 | 0.05 | 0.05 |
| Polyol(s) | 52-55 | 45-60 | 0 | 0 | 52-62 | 50-65 |
| Sugar | 0 | 0 | 51-60 | 50-59 | 0 | 0 |
| Triacetin | 0.1-0.3 | 0.2-0.5 | 0.2-0.4 | 0 | 0 | 0 |
| Hydrogenated | 0 | 0 | 0.25 | 0.25 | 0.25 | 0.25 |
| Starch Hydrolysate | | | | | | |
| Flavors | 2.50 | 2.50 | 2.26 | 2.26 | 2.26 | 2.50 |
| Cooling agent | 0.08 | 0.08 | 0 | 0 | 0 | 0.08 |
| Intense sweetener | 3.40 | 3.40 | 3.40 | 3.40 | 3.40 | 3.40 |

The center-fill composition is prepared by combining the components set forth in Examples 10G-10L in Table 6. The amounts included are based on the weight percent of the total center-fill composition.

TABLE 6
Center-Fill Composition

| | % by weight | | | | | |
|---|---|---|---|---|---|---|
| Component | G | H | I | J | K | L |
| Sugar | 42-48 | 42-48 | 0 | 0 | 42-48 | 0 |
| Corn Syrup | 42-48 | 42-48 | 0 | 0 | 42-48 | 0 |
| Polyol(s) | 0 | 0 | 84-96 | 84-96 | 0 | 84-96 |
| Lecithin | 0.75-1.0 | 0 | 0.1-0.25 | 0.25-0.5 | 0.5-0.75 | 0 |
| Guar Gum | 0.1-0.7 | 0 | 0.1-0.7 | 0 | 0.1-0.7 | 0 |
| Citric Acid | 0.7-4.5 | 0.7-4.5 | 0.7-4.5 | 0.7-4.5 | 0.7-4.5 | 0.7-4.5 |
| Flavor | 0.05-.30 | 0.025-0.1 | 0.05-.30 | 0.05-.30 | 0.025-0.1 | 0.05-0.3 |
| Color | 0.1-0.7 | 0.1-0.7 | 0.1-0.7 | 0.1-0.7 | 0 | 0 |

The coating composition is prepared by combining the components set forth in 10M-10R in Table 7. The amounts included are based on the weight percent of the total coating composition.

TABLE 7
Coating Composition

| | % by weight | | | | | |
|---|---|---|---|---|---|---|
| Component | M | N | O | P | Q | R |
| Sugar | 84-96 | 84-96 | 84-96 | 0 | 0 | 0 |
| Polyol(s) | 0 | 0 | 0 | 84-96 | 84-96 | 84-96 |
| Gelatin | 1-3 | 1-3 | 1-3 | 1-3 | 1-3 | 1-3 |
| Titanium dioxide | 0-2 | 0-2 | 0-2 | 0-2 | 0-2 | 0-2 |
| Flavor(s) | .75-1.25 | 1.0-1.5 | 0.5-1.0 | 0.5-1.0 | 0.25-0.75 | 0.25-0.75 |
| Cooling agent(s) | 0-0.1 | 0-0.1 | 0.1-025 | 0.1-0.25 | 0.1-0.25 | 0-0.1 |
| Intense | 0.05-0.25 | 0.05-0.25 | 0.1-0.4 | 0.1-0.4 | 0.1-0.4 | 0.05-0.25 |
| sweetener(s) | | | | | | |
| Color | 0-0.1 | 0-0.1 | 0-0.1 | 0-0.1 | 0-0.1 | 0-0.1 |
| Candelilla wax | 0.015-0.05 | 0.015-0.05 | 0.015-0.05 | 0.015-0.05 | 0.015-0.05 | 0.015-0.05 |

The center-fill gum products are prepared in accordance with the general method described in Example 1 above. Any of the center-fill compositions of Examples 10A-10F are incorporated into any of the gum region compositions of Examples 10G-10L, and then any of the coating compositions of Examples 10M-10R are applied to the exterior. The center-fill is added in an amount from about 5% by weight to about 25% by weight of the total composition. The gum region is added in an amount of from about 50% by weight to about 90% by weight of the total composition. The coating composition is added in an amount of from about 5% by weight to about 15% by weight of the total composition.

1. A chewing gum composition comprising:
a. a center-fill composition; and
b. a gum region surrounding said center-fill composition, said gum region comprising a gum base and triacetin;
wherein said triacetin is present in an amount of from about 0.1% to about 2% by weight of the chewing gum composition.

2. The composition of claim 1, wherein said composition comprises a gum piece in the form of a pellet.

3. The composition of claim 2, wherein said pellet has a length of about 18 mm to about 22 mm.

4. The composition of claim 2, wherein said pellet has a width of about 12 mm to about 16 mm.

5. The composition of claim 2, wherein said pellet has a thickness of about 7 mm to about 10 mm.

6. The composition of claim 2, further comprising a coating surrounding at least a portion of said pellet.

7. The composition of claim 6, wherein said coating has a thickness of about 1 micron to about 7 mm.

8. The composition of claim 1, wherein said gum region has a non-uniform thickness.

9. The composition of claim 1, wherein said gum base comprises polyvinyl acetate, said polyvinyl acetate having a molecular weight of at least about 55,000.

10. The composition of claim 1, wherein said gum base comprises at least one filler, said filler having a surface area of from about 3 to about 6 m²/g.

11. The composition of claim 1, wherein said gum base comprises a bulk sweetener, said bulk sweetener having a surface area of from about 0.1 to about 4 m²/g.

12. The composition of claim 1, wherein said gum base comprises talc, said talc having an average particle size of from about 5 microns to about 25 microns.

13. A chewing gum composition comprising:
a. a center-fill composition comprising lecithin; and
b. a gum region surrounding said center-fill composition, said gum region comprising a gum base,
wherein said lecithin is present in an amount of from about 0.01% to about 1.0% by weight of the chewing gum composition.

14. The composition of claim 13, wherein said composition comprises a gum piece in the form of a pellet.

15. The composition of claim 14, wherein said pellet has a length of about 18 mm to about 22 mm.

16. The composition of claim 14, wherein said pellet has a width of about 12 mm to about 16 mm.

17. The composition of claim 14, wherein said pellet has a thickness of about 7 mm to about 10 mm.

18. The composition of claim 14, further comprising a coating surrounding at least a portion of said pellet.

19. The composition of claim 13 wherein said composition further comprises a flavor oil present in an amount that is about 10% less than normally required to achieve the same taste perception.

20. The composition of claim 13, wherein said gum base comprises polyvinyl acetate, said polyvinyl acetate having a molecular weight of at least about 55,000.

21. The composition of claim 13, wherein said gum base comprises at least one filler, said filler having a surface area of from about 3 to about 6 m²/g.

22. The composition of claim 13, wherein said gum base comprises a bulk sweetener, said bulk sweetener having a surface area of from about 0.1 to about 4 m²/g.

23. The composition of claim 13, wherein said gum base comprises talc, said talc having an average particle size of from about 5 microns to about 25 microns.

24. The composition of claim 13, wherein said gum region comprises triacetin in an amount of from about 0.1% to about 2% by weight of the composition.

25. The composition of claim 24, wherein said chewing gum composition further includes a flavor oil present in an amount that is lesser than normally required to achieve the same taste effect.

26. A method of preparing a multi-layer center-fill gum product comprising the steps of
a. extruding a center-filled rope comprising a center-fill composition and a chewing gum layer surrounding said center-fill composition, said chewing gum layer comprising triacetin:
b. sizing said rope;
c. feeding said rope into a tablet-forming mechanism;
d. forming individual pieces of chewing gum from said center-filled rope;
c. coating said individual pieces with a hard coating.

27. The method of claim 26, wherein said center-fill composition comprises lecithin.

28. A chewing gum composition comprising:
a. a gum region comprising:
i. a gum base;
ii. talc;
iii. lecithin;
iv. triacetin;
v. hydrogenated starch hydrolysate;
vi. at least one polyol;
vii. at least one flavor;
viii. at least one acid; and
ix. at least one sweetener;
b. a center-fill region comprising:
i. glycerin;
ii. hydrogenated starch hydrolysate;
ii at least one sweetener;
iv. xanthan gum;
v. lecithin
vi. at least one acid; and
vii. at least one flavor;
c. a coating comprising:
i. at least one polyol;
ii. gelatin;
iii. titanium dioxide;
iv. at least one flavor;
v. at least one sweetener; and
vi. wax.
